(19) United States
(12) Patent Application Publication
(10) Pub. No.: US 2026/0197312 A1
(43) Pub. Date: Jul. 9, 2026

(54) SUPERIMPOSED BIOMETRIC AUTHENTICATION

(71) Applicant: Visa International Service Association, San Francisco, CA (US)

(72) Inventor: Gokul Anand Manimaran, Banglore (IN)

(73) Assignee: Visa International Service Association, San Francisco, CA (US)

(21) Appl. No.: 19/129,548

(22) PCT Filed: Nov. 23, 2022
(86) PCT No.: PCT/US2022/050941

§ 371 Date: May 13, 2025

(51) Int. Cl. H04L 9/40

(52) U.S. Cl. CPC H04L 63/0861

(57) ABSTRACT

Embodiments of the present disclosure are directed to methods and systems for biometric authentication using superimposed biometric data. Using such methods and systems, a user can be authenticated for some purpose (e.g., gaining access to a secure facility, accessing a user account, etc.). Superimposed biometric data, unlike conventional biometric data, can comprise a combination of user biometric data and artificial biometric data. This combination can protect the user biometric data. For example, if an identity thief manages to acquire the superimposed biometric data, it may be difficult or impossible for the identity thief to acquire the user biometric data, thereby protecting the user's data privacy. The user can use a user device to capture and combine the user's biometric data with artificial biometric data stored on the user device, thereby determining superimposed biometric data, which can be sent to a biometric authentication server in order to authenticate the user.

### BACKGROUND

Authentication generally refers to processes that can be used to verify the identity of something, e.g., a person, computer system, etc. For people, authentication usually refers to processes used to verify the identity of a person, or verify that a person has a credential or privilege that grants them access to some service or resource. For example, a person can be authenticated to verify that they have access to confidential or classified documents.

Biometric data collected from living organisms (e.g., people) can be used to perform authentication processes. For example, human fingerprints are detailed, nearly unique, difficult to alter, and consistent over a person's lifetime. These properties make them suitable as authenticators of human identity. The use of fingerprints as identification has existed since at least 300 AD in China, but was not broadly adopted until the 20th century.

In recent years, biometric authentication has become a more common method of authenticating users. Many smartphones have a built in fingerprint scanner, which enables users to unlock their phones by pressing a finger or thumb against the scanner interface. This scanner interface can be built into the smart phone screen. Such systems can be convenient to users, who may no longer need to remember passwords in order to access their smartphones.

An additional use for biometric data is to authorize resource or service transfers (e.g., transactions). For example, when a user attempts to use their smartphone to purchase an application in an application store, the user may be prompted to provide a biometric sample, such as a scan of a fingerprint, an iris, their face, etc. The smartphone can use biometric data derived from the biometric sample to verify the identity of the user, e.g., by comparing the provided biometric data to biometric data stored in secure memory on the smartphone. If the user's biometric data matches the stored biometric data, the smartphone can enable a transfer of funds between the user's account and the application store, completing the purchase of the application. This can prevent people who are not the user (e.g., fraudsters, the user's unsupervised children) from making purchases using the user's funds without the user's permission.

However, there are some issues with biometric authentication that limits its widespread adoption. Due to the properties of biometric data described above (e.g., detail, uniqueness, difficulty to alter, and lifetime consistency), biometric data is generally considered a strong authenticator, meaning that if a person presents valid biometric data, they are assumed to be the who they claim to be. In many modern systems however, biometric data is often distributed and transmitted over networks such as the Internet. This provides an opportunity for identity thieves to intercept and steal biometric data. An identity thief can use stolen biometric data to impersonate someone and access confidential or classified files, or make purchases, apply for a loan, or open up a credit card in their name.

As such, the risk of biometric theft is a security problem that prevents the widespread adoption of otherwise useful biometric authentication technologies. Embodiments of the present disclosure address this problem and other problems, individually and collectively.

### SUMMARY

Embodiments of the present disclosure are directed to methods and systems for performing biometric authentication, particularly using “superimposed biometric data” a novel digital representation of biometric data that provides additional security features. Superimposed biometric data can comprise a combination of user biometric data (e.g., a digital representation of a user's fingerprint) and artificial biometric data (e.g., a digital representation of a “fake” fingerprint, or any other data that can be used to obfuscate the user biometric data). By using superimposed biometric data, the user's biometric data can be protected from identity thieves, who may intercept biometric data transmitted over networks such as the Internet. In this way, embodiments of the present disclosure improve user security by using superimposed biometric data.

Biometric data can comprise a large number of features. A fingerprint, for example, can comprise arches (e.g., plain arches, tented arches, radial arches, ulnar arches, etc.), whorls (e.g., plain whorls, central pocket whorls, double loops, accidental whorls, etc.), loops, ridges, forks, hooks, islands, enclosures, etc. These features can additionally have various sizes and positions. As a consequence, when an artificial fingerprint is “superimposed” on a user fingerprint, there may be a very large number of combined features.

It is difficult, if not impossible to determine which specific combination of superimposed biometric features correspond to user biometric data and which combination of features correspond to artificial biometric data. As the number of features increases, the number of possible configurations of user biometric data grows factorially. Even assuming a relatively small number of features, for example 10 feature user biometric data and 10 feature artificial biometric data, there are approximately 184,756 possible 10 feature user biometric data configurations that could be constructed from those 20 features, and only one of those 184,756 possibilities is the real user biometric data. Hence it is extremely unlikely that an identity thief can successfully determine user biometric data, even with possession of superimposed biometric data, as the identity thief has a low probability of determining which specific combination of features (from the superimposed biometric data) correspond to the user biometric data.

Embodiments of the present disclosure can be used in situations or use cases in which a user is being authenticated using user biometric data. As an example, this could include use cases in which user biometric data is used to authenticate a user and provide that user access to a secure facility (e.g., a government laboratory). As another example, during a credit card transaction, a user could be biometrically authenticated in order to verify that the user is making the transaction, and not a thief who has stolen the user's credit card.

One embodiment is directed to a method performed by a user device. The user device (e.g., a smartphone, a smartcard, a laptop, etc.) can interface with an access device (e.g., a point of sale terminal, a building access control system, etc.). A user can, for example, put the user device in close proximity to the access device, thereby enabling the devices to interface via near-field communication. The user device can determine superimposed biometric data comprising a combination of user biometric data and artificial biometric data. For example, the user device can use a biometric capture layer (e.g., a sensor) located on the user device to capture a user biometric sample (e.g., a fingerprint) and generate user biometric data, then combine that user biometric data with artificial biometric data stored on the user device, thereby determining the superimposed biometric data. Afterwards, the user device can transmit the superimposed biometric data and a user device identifier to a biometric authentication computer. In some embodiments, the user device can transmit the superimposed biometric data and the user device identifier to the biometric authorization computer via the access device.

The biometric authentication computer can verify that the superimposed biometric data corresponds to a user corresponding to the user device, e.g., by using the superimposed biometric data and the user device identifier. Another embodiment is directed to a method performed by a biometric authentication computer for performing this verification process. The biometric authentication computer can receive a request message comprising a user device identifier and superimposed biometric data. The biometric authentication computer can identify user biometric data and artificial biometric data corresponding to the user device identifier, e.g., by looking up a user record in a user database using the user device identifier.

The biometric authentication computer can then verify the superimposed biometric data using the user biometric data and the artificial biometric data, thereby verifying that the superimposed biometric data corresponds to a user corresponding to the user device corresponding to the user device identifier. The biometric authentication computer can generate an indicator, which can indicate whether the superimposed biometric data was successfully verified. The biometric authentication computer can transmit this indicator, e.g., to an access device or to an authorization computer, which may authorize some event or action based in part on the indicator (e.g., allow the user access to a secure facility, authorize a transaction taking place between the user and a merchant, etc.)

Other embodiments are directed to devices and systems, including a user device comprising a processor, a biometric capture layer, and a non-transitory computer readable media coupled to the processor, the non-transitory computer readable media comprising code, executable by the processor, for performing methods according to embodiments, e.g., the method performed by the user device described above.

### Terms

A “server computer” may refer to computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “memory” may refer to any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and or Xscale; and/or the like processor(s).

A “message” may refer to any information that may be communicated between entities. A message may be communicated by a “sender” to a “receiver.” A sender may refer to any originator of a message and a receiver may refer to any recipient of a message. Most forms of digital data (including e.g., biometric data, text files, video files, cryptographic keys, etc.) can be represented as messages.

A “user” may refer to an entity that uses something for some purpose. An example of a user is a person who uses a “user device” or a “mobile device.” A user device may refer to any device operated by a user, such as a smartphone, smartcard, wearable device, laptop, tablet desktop computer, etc. A “mobile device” may refer to a device that is mobile, such as a smartphone, smartcard, smartwatch, other wearable device, etc. A mobile device may also be used by a user. Many mobile devices can be user devices, and likewise many user devices can be mobile devices. Generally the terms user device and mobile device are used herein to differentiate between two devices when two devices are present in a system or used in a method. User devices and mobile devices may comprise “electronic elements,” e.g., integrated circuit “chips,” capacitors, resistors, etc.

“Biometrics” may refer to the analysis, particularly statistical analysis of biological data. A “biometric sample” may refer to something derived from a “biometric source,” which may be used to perform such analysis. A “biometric source” may refer to a biological entity or part of a biological entity from which a biometric sample can be derived. For example, a finger can be a biological source used to produce a fingerprint, which can comprise a biological sample. Likewise, an eye may be a biological source used to produce an iris scan biological sample. The term “biometric data” may refer to any data which is representative of biometrics, including biometric samples. For example, a digital representation of a fingerprint, iris scan, voice recording, etc. (stored digitally in a file or data record) can comprise biometric data. “Biometric templates,” mathematical representations of unique fingers in biometric samples are a form of biometric data. “User biometric data” may refer to biometric data corresponding to a user (e.g., a user of a user device). “Artificial biometric data” may refer to biometric data (or data formatted to appear as biometric data) which does not correspond to a real biometric sample. As an example, a machine learning model can be trained to generate artificial biometric data using real biometric data as training data. Such artificial biometric data may appear to be real biometric data, but is not derived from an actual biological entity.

“Authentication” may refer to the process or action of proving or showing something to be true, genuine, or valid. Authenticating a user may refer to a process of verifying the identity of the user, e.g., verifying that the user is who they claim to be.

A “resource provider” may refer to an entity that provides a “resource.” A “resource” which may broadly refer to something which can be provided. Examples of resources include material resources, such as iron, monetary resources, such as dollars, and consumer goods, such as cleaning supplies, clothing, food, etc. Resources may also refer to services, such as cleaning services. Access to something may also qualify as a resource, e.g., access to a secure building. Examples of resource providers include merchants, government entities, guards, etc. A resource provider may operate a “resource provider computer.”

A “transport computer” may refer to a computer that transports data from one computer to another computer. A transport computer may comprise an intermediary in a computer network such as the Internet. In some cases, a transport computer may be operated by an “acquirer” or “acquiring bank,” an entity that performs banking services on behalf of a resource provider (e.g., a merchant).

An “authorization computer” may refer to a computer system that is used to authorize some action or interaction between entities. For example, an authorization computer can be used to authorize a transaction between a user and a (merchant) resource provider. In some cases, an authorization computer may be operated by an “issuer” or “issuing bank,” an entity that performs banking services on behalf of a user. The owner or operator of an authorization computer may be referred to as an authorizing entity. For example, an issuing bank can comprise an authorizing entity.

An “authorization request message” may refer to a message sent to an authorization computer, requesting authorization for some action or interaction. For example, an authorization request message can request authorization for a transaction conducted between a (merchant) resource provider and a user. As another example, an authorization request message can request authorization to grant a user access to a secure facility, e.g., a government laboratory. An “authorization response message” may refer to a message sent by an authorization computer that is responsive to an authorization request message. An authorization response message can, for example, confirm or deny authorization. Authorization request and response messages can conform to any appropriate communication protocol or standard, including ISO 8583, a standard for exchanging payment card information.

A “processing computer” may refer to a computer system that processes data or messages transmitted between computers in a network. As an example, a processing computer can receive messages, determine their intended recipient, and transmit those received messages to their intended recipient. A processing computer can comprise part of a “processing network,” such as a payment processing network.

A “database” may refer to a structured set of data held in a computer or a device. Alternatively, a database may refer to a device which holds such a structured set of data. A “data record” may refer to an element of data stored in a database. For example, a zoo database may maintain a record for each animal interred at the zoo. A data record may correspond to a user, in which case it may be referred to as a “user data record” or “user record.”

An “access device” may refer to a device used to access something, such as a network or computer system. For example, a point of sale terminal can comprise an access device used to gain access to a payment processing network. An access device may comprise a means by which it can interface with other devices. For example, an access device may include a “chip card reader,” including conductive contacts used to interface with a smartcard user device.

An “identifier” may refer to any data which may be used to identify something, such as an entity, computer, device, account, etc. Examples of identifiers include names, social security numbers, serial numbers, SIM numbers, credit card numbers, account numbers, usernames, etc. A “user device identifier” may refer to an identifier that can be used to identify a particular user device.

### BRIEF DESCRIPTION OF THE DRAWINGS

FIG. 1 shows an example of superimposed biometric data, user biometric data and artificial biometric data.

FIG. 2 shows an exemplary biometric authentication system according to some embodiments of the present disclosure.

FIG. 3 show an exemplary user device according to some embodiments.

FIG. 4 shows another depiction of an exemplary user device according to some embodiments.

FIG. 5 shows an authentication computer according to some embodiments.

FIG. 6 shows a sequence diagram of an exemplary user onboarding process according to some embodiments.

FIG. 7 shows a sequence diagram of an exemplary biometric authentication process according to some embodiments.

FIG. 8 shows a flowchart of an exemplary biometric capture process according to some embodiments.

FIG. 9 shows a diagram of an exemplary optical biometric capture system according to some embodiments.

FIG. 10 shows a diagram of an exemplary mutual capacitance biometric capture system according to some embodiments.

FIG. 11 shows a diagram of an exemplary ultrasonic biometric capture system according to some embodiments.

FIG. 12 shows a first exemplary biometric verification process according to some embodiments.

FIG. 13 shows a second exemplary biometric verification process according to some embodiments.

FIG. 14 shows a third exemplary biometric verification process according to some embodiments.

FIG. 15 shows a flowchart of an exemplary artificial biometric update process according to some embodiments.

### DETAILED DESCRIPTION

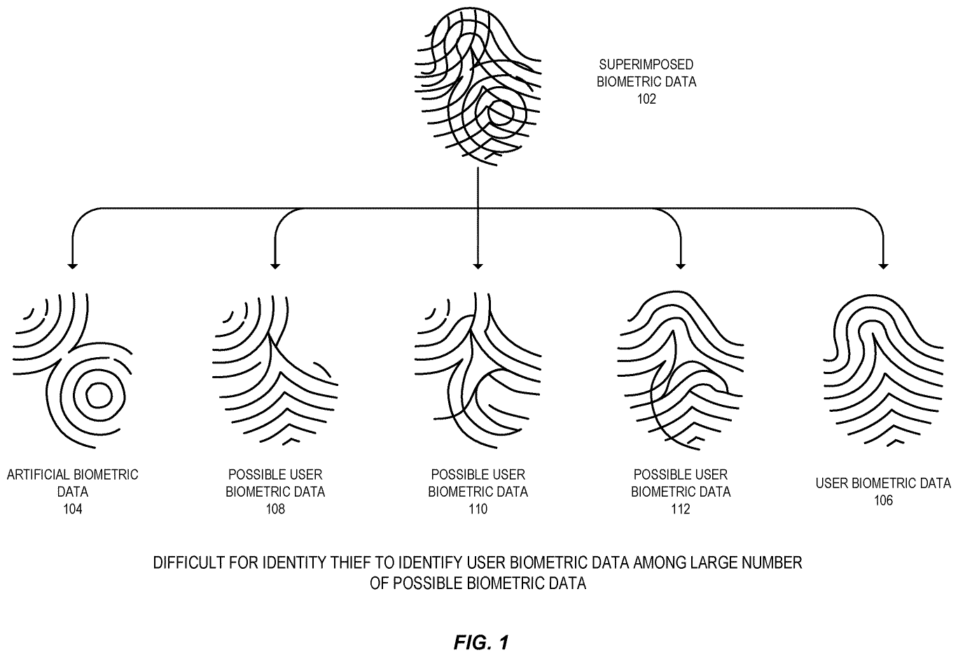

As described above in the Summary, embodiments of the present disclosure are directed to methods and systems that enable the biometric authentication of users using superimposed biometric data rather than conventional biometric data. Instead of directly authenticating a user using the user's biometric data (which can be intercepted, stolen, and used by an identity thief), embodiments of the present disclosure enable authentication using superimposed biometric data, which can comprise a combination of user biometric data and artificial biometric data. While an identity thief can still potentially steal superimposed biometric data, it may be difficult or impossible for the thief to determine the user biometric data from the superimposed biometric data. This concept is illustrated by FIG. 1.

FIG. 1 shows superimposed biometric data 102, comprising a combination of user biometric data 106 and artificial biometric data 104. In FIG. 1, the biometric data is represented by fingerprints for ease of illustration, and the superimposed biometric data 102 is represented as a direct superimposition of a real fingerprint (e.g., corresponding to a user's finger) and an artificial fingerprint (e.g., generated by a biometric authentication computer). However, any form of user biometric data and artificial biometric data can conceivably be superimposed, such as digital representations of iris scans, facial scans, voice recordings, etc. It should be further noted that biometric data may be stored or interpreted by computers or devices in non-image form. e.g., fingerprint biometric data may be represented by a feature vector, which can comprise a list of elements (numerical or otherwise) that can be used to describe relevant characteristics (i.e., features) of the fingerprint. As such, it should be understood that FIG. 1 is intended to illustrate and explain some advantages provided by embodiments of the present disclosure, but not to limit such embodiments.

If an identity thief somehow acquires the superimposed biometric data 102, they may attempt to determine the user biometric data 106 based on the superimposed biometric data 102. However, there are a large number of possible configurations of user biometric data. FIG. 1 shows just three examples 108-112. Each of these examples “looks like” a real fingerprint. Consequently, even if the identity thief is able to generate each and every possible configuration of user biometric data, it is difficult or impossible for the identity thief to identify the real user biometric data 106 among all the possibilities.

While an identity thief could conceivably steal and use the superimposed biometric data 102 itself to impersonate the user, embodiments of the present disclosure still provide greater security than conventional biometric authentication systems. User biometric data derived from a semi-immutable part of a user's body (e.g., a fingerprint, an iris) cannot be “reissued” if stolen. If an identity thief steals user biometric data, they possess that biometric and can use it to impersonate a user. However, artificial biometric data can be generated and reissued relatively easily. If it is suspected that a superimposed biometric has been stolen, new artificial biometric data can be issued to a user. Using the new artificial biometric data and the user biometric data, new superimposed biometric data can be generated. At this point, the identity thief can no longer use the stolen superimposed biometric data to impersonate the user.

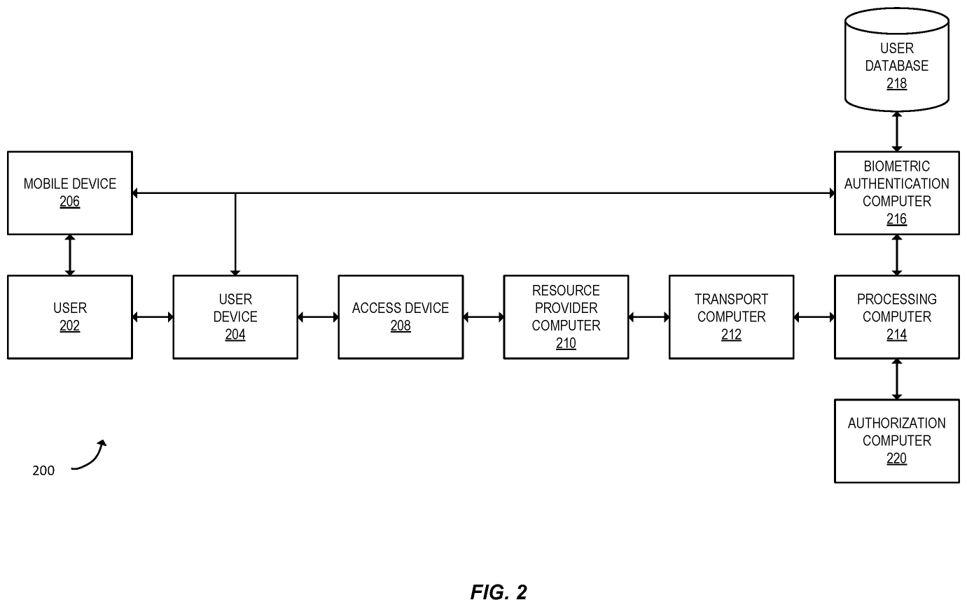

FIG. 2 shows an exemplary biometric authentication system 200 according to some embodiments. In the system 200, a biometric authentication computer 216 can use superimposed biometric data provided by a user device 204 in order to authenticate a user 202. Such superimposed biometric data may be transmitted between computers or devices as it moves through the system 200.

The devices and computers in the system 200 can communicate with one another using a communication network (not pictured), such as a cellular communication network or the Internet. However, it should be understood that such a communication network can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers and devices in system 200 may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

Messages sent between the computers and devices in system 200 may be transmitted in encrypted or unencrypted form. As an example, superimposed biometric data transmitted from user device 204 to biometric authentication computer 216 (via the other computers and devices in the system 200) may be encrypted. If messages are encrypted, the computers and devices in system 200 can use a public key infrastructure, perform a key exchange (e.g., a Diffie-Hellman key exchange), or use any other appropriate means to enable the computers and devices to encrypt and decrypt messages.

When communicating over a network such as the Internet, there is a reasonable probability that messages or other data sent between two computers or devices in the system 200 may be routed between an indeterminate number of intermediary computers or devices. For simplicity's sake, such intermediate computers are not included in FIG. 2. Further, in some embodiments, not all computers and devices in FIG. 2 may be necessary to complete methods according to embodiments. For example, the biometric authentication computer 216 and the authorization computer 220 could comprise a single computer system, and the access device 208 could communicate directly with the combined biometric authentication computer 216 and authorization computer 220, rather than communicating via the resource provider computer 210, the transport computer 212, and the processing computer 214.

The particular configuration of computers and devices in FIG. 2 was selected to illustrate some useful applications of embodiments of the present disclosure, particularly the general application of resource provisioning. A resource provider operating a resource provider computer 210 can use the system 200 to biometrically authenticate the user 202 in order to verify that they are eligible to receive a resource. If the user 202 is successfully biometrically authenticated, the resource provider can then provide the user 202 with that resource.

One example of a resource is access to a secure or otherwise access-controlled location. An example of such a location is a government facility. In this example, the user device 204 could comprise a smart ID card, the access device 208 could comprise a terminal that interfaces with the smart ID card, the resource provider computer 210 could comprise a computer system operated by a resource provider (e.g., a guard who is guarding the entrance to the access-controlled location), and the transport computer 212, processing computer 214, biometric authentication computer 216, user database 218, and authorization computer 220 could comprise part of a computer network for building. In this example, the system 200 can be used to biometrically authenticate the user 202, and thereby verify that the user 202 has access to the government facility. If the user is successfully authenticated, the guard can grant the user 202 access, e.g., by unlocking a door. If the user 202 is not successfully authenticated, the guard can take any appropriate steps, e.g., asking the user 202 to leave, offering the user 202 a chance to re-attempt biometric authentication, etc.

Another example of a resource is a good or service provided by a merchant. In such a case, the system 200 can be used to biometrically authenticate the user in order to verify that the user 202 is authorized to perform a transaction with the merchant. In this example, the user device 204 can comprise a credit card, the access device 208 can comprise a point of sale terminal, the resource provider computer 210 could comprise a merchant computer connected to the point of sale terminal, the transport computer 212 could comprise an acquirer computer associated with an acquiring bank that manages an account on behalf of the merchant, the processing computer 214 could comprise a computer that is part of a payment processing network (e.g., the Visa payment processing network), and the authorization computer 220 could comprise an “issuer computer” associated with an “issuing bank” that manages an account on behalf of the user 202, and which may have issued the user device 204 to the user. In this case, the system 200 can comprise a “four party network” (sometimes referred to as a “four party scheme”), a system used to enact credit card transactions. However, unlike a conventional four party network, the system of FIG. 2 additionally comprises the biometric authentication computer 216 and user database 218.

In this payment context, the user device 204 (e.g., credit card) may include superimposed biometric data along with any credit card data (e.g., data used in a normal credit card transaction) which may be transmitted to the access device 208 (e.g., a point of sale terminal) during an interfacing. Examples of interfacing can include inserting the user device 204 into the access device 208, sliding the user device 204 through a magnetic strip reader located on the access device 208, tapping the user device 204 against the access device 208 to activate near field communication, etc. The access device 208 can include the superimposed biometric data in an authorization request message, which can be routed through the system 200 to the processing computer 214 (e.g., a server computer associated with a payment processing network such as Visa). The processing computer 214 can analyze the authorization request message, and determine that it includes superimposed biometric data. The processing computer 214 can then transmit the superimposed biometric data to the biometric authentication computer 216 for analysis.

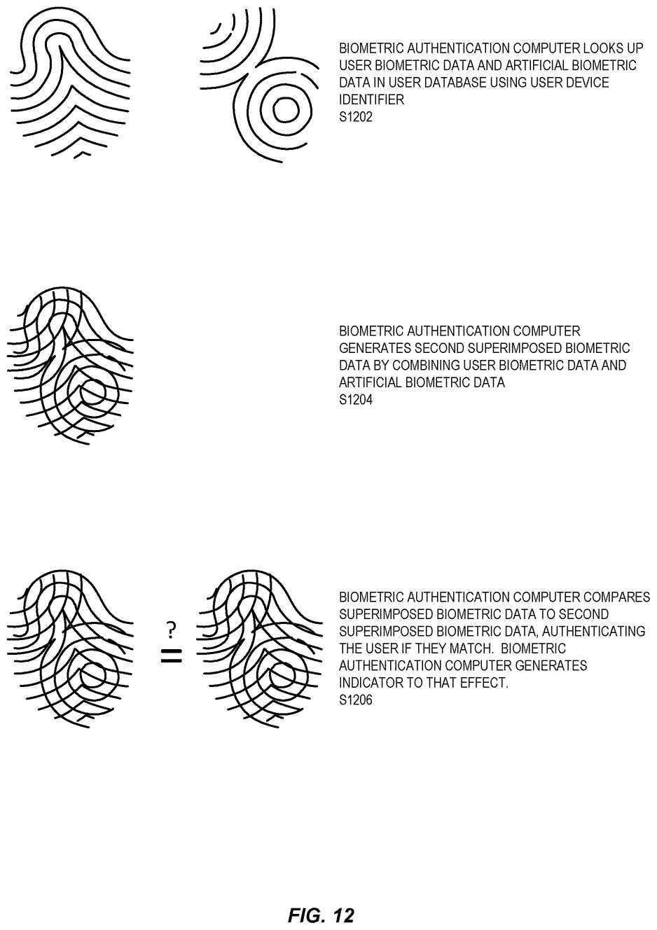

The biometric authentication computer 216 can analyze the superimposed biometric data to authenticate the user 202 using methods described in detail further below, particularly with reference to FIGS. 12-14. Such methods may involve the biometric authentication computer 216 accessing a user record corresponding to the user 202 in the user database 218, which may contain user biometric data that may be useful for authenticating the user 202. Afterwards, the biometric authentication computer 216 can generate an “indicator” indicating whether the user 202 has been successfully authenticated. The indicator can be returned to the processing computer 214. The processing computer 214 can transmit the authorization request message along with the indicator to the authorization computer 220 (e.g., a computer system associated with the user's 202 bank).

The authorization computer 220 can analyze the authorization request message and the indicator and determine whether or not to authorize the transaction. Such analysis can include risk evaluation, and can include evaluating the indicator, a transaction amount, the time of the transaction, the recent frequency of transactions, etc. The authorization computer 220 can generate an authorization response message, indicating whether the transaction has been approved or denied.

Generally, if the user 202 is biometrically authenticated successfully, it is expected that the authorization computer 220 will generate an authorization response message authorizing the transaction, whereas if the user 202 is not authenticated successfully, it is expected that the authorization computer will generate an authorization response message that does not authorize the transaction. However, there may be mitigating or extenuating circumstances, e.g., a user 202 may have a monetary limit on purchase amounts, which may lead to an authorization response message that denies the transaction, even if the user 202 was successfully biometrically authenticated. Alternatively, if the issuing bank (operating the authorization computer 220) is aware that the user device 204 is malfunctioning and failing to generate legitimate superimposed biometric data, the authorization computer 220 may approve low-risk transactions, even if the user 202 is not biometrically authenticated successfully.

A resource provider does not necessarily need to be human or an organization. In some cases, a smart building can function as a resource provider, e.g., by opening a mechanized lock to grant the user access to an access controlled location. Likewise, an online retailer may perform transactions with user 202 without any direct participation by a human employee.

Many of the entities, computers and devices in system 200 are described in further detail with reference to the other figures. Additionally, many of these computers and devices can be understood contextually based on the description above. However, for the sake of completeness, these entities, computers and devices are summarized below.

The user 202 can comprise an operator of user device 204 and mobile device 206. The user 202 can produce biometric samples that can be captured in order to generate or determine biometric data, which can be used to biometrically authenticate the user 202. Examples of such biometric samples include facial scans, iris scans, retina scans, vocal recordings, fingerprints, etc. Fingerprints are often used as an example throughout this disclosure, but it should be understood that embodiments of the present disclosure can be practiced using other forms of biometric samples. A user's 202 biometric samples can be derived from a “biometric source.” As examples, for fingerprint biometric samples, the biometric source can comprise a finger, and for a iris scan biometric sample, the biometric source can comprise the user's 202 eye.

The user device 204 can comprise a device operated by the user 202, such as a smartcard, smartphone, wearable device (e.g., a smartwatch), a laptop, a tablet, a desktop computer, etc. The mobile device 206 can comprise similar devices. As such, in this disclosure, if the user device 204 is described as being able to possess a particular component (e.g., a processor, a memory, an antenna, a biometric interface, etc.) or quality (e.g., the ability to communicate via near field communication, the ability to combine user biometric data and artificial biometric data, etc.) it should be understood generally that the mobile device 206 can also possess these components or qualities, and as such, the specific components, qualities, or characteristics of mobile device 206 are not described in great detail herein.

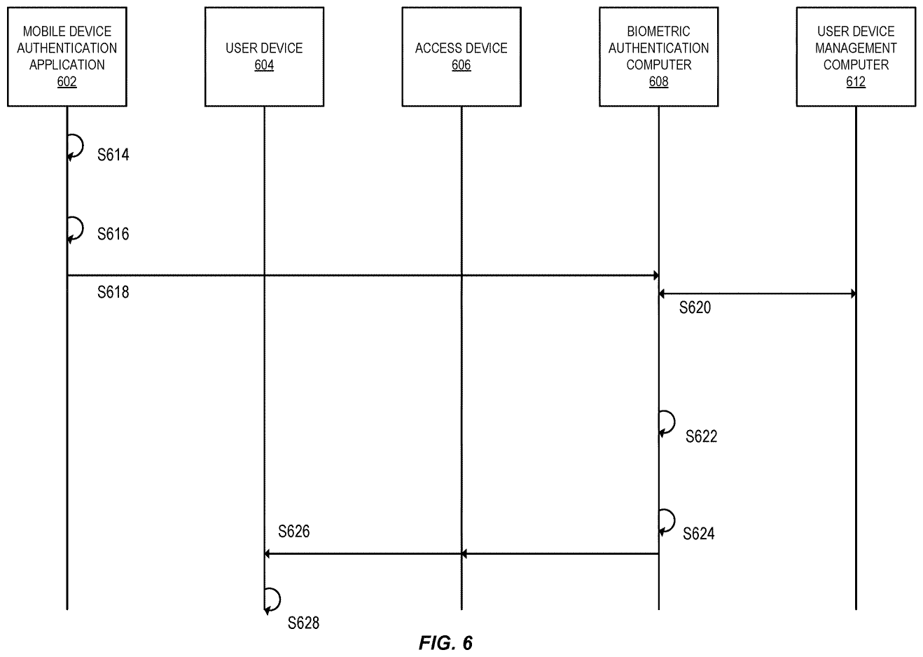

In some embodiments, the user device 204 and mobile device 206 may comprise a single device, e.g., a smartphone may function as both the user device 204 and mobile device 206. Generally, the term mobile device is used to differentiate it from the user device 204 in embodiments in which there are a separate mobile device 206 and user device 204. For example, if the user device 204 comprises a smartcard (which generally does not operate user applications, provide a user interface, browse the Internet, etc.), the mobile device 206 may comprise a smartphone, which can use an application, user interface, or web browser which can be used by the user 202 to enroll in the biometric authentication program, as described further below with reference to FIG. 6.

The user device 204 can possess a processor, a memory, and some means to capture biometric data, which is referred to herein as a “biometric capture layer.” A biometric capture layer could comprise, for example, a camera used to capture a facial scan, iris, scan, retina scan, optical fingerprint scan, etc. In some embodiments (particularly those relating to the use of smartcard user devices 204), these components may be driven by an internal power source, and instead may be powered by an external source, such as electrical power received from access device 208 during near field communication.

In summary terms, the user device 204 can function to capture user biometric data from the user 202 via its biometric capture layer, and combine that user biometric data with artificial biometric data stored on the user device 204, thereby generating or determining superimposed biometric data. The user device 204 can then transmit this superimposed biometric data to biometric authentication computer 216, e.g., via access device 208 and the system 200.

The access device 208 can comprise any device or system capable of interfacing with the user device 204 and communicating with the biometric authentication computer 216 and authorization computer 220 via the processing computer 214, a network such as the Internet or a cellular communications network, or any combination thereof. An example of an access device 208 is a point of sale terminal, which interfaces with user devices 204 (credit cards) to enable credit card transactions between users 202 and resource providers associated with resource provider computer 210. An access device 208 can comprise one or more communication interfaces, such as a magnetic stripe reader, EMV chip interface, near field communication interface, USB interface, Ethernet interface, etc. The access device 208 can use these interfaces to interface with the user device 204 and communicate with the biometric authentication computer 216 and authorization computer 220. In general, the access device 208 can collect superimposed biometric data and a user device identifier from the user device 204, generate messages (such as request messages or authorization request messages) containing the superimposed biometric data and user device identifier, transmit those messages to the biometric authentication computer 216, and receive authorization response messages from the authorization computer 220.

Resource provider computer 210 can comprise any computer system associated with a resource provider. For example, this could be a computer system located at a check-out line, an inventory management system, a central server computer associated with an online retailer, a building access control system, etc. In general, the resource provider computer 210 can be connected in some manner to the access device 208 (e.g., via Ethernet or a phone jack) and can forward authorization request messages generated by the access device 208 to the processing computer 214. Additionally, the resource provider computer 210 can receive authorization response messages from the authorization computer 220, and the resource provider computer 210 may perform some action responsive to received authorization response messages. As an example, a building access control system, upon receiving an authorization response message indicating that a user 202 is authorized to access the building, may send a signal to an electronic lock thereby unlocking a door to the building. As another example, upon receiving an authorization request message indicating that a user 202 is authorized to complete a transaction, a resource provider computer 210 comprising a self-checkout kiosk at a grocery store may print out a receipt and display an indication that a customer is free to leave with their purchases.

Transport computer 212 may comprise a computer system that transports messages, request messages, and authorization request messages to the processing computer 214. In some embodiments, the transport computer 212 can comprise an acquirer computer associated with an acquiring bank, which can maintain an account corresponding to a merchant resource provider. Later, upon biometric authentication of the user 202 and completion of a transaction, the transport computer 212 may be involved in a clearing and settlement process, used to enact a transfer of funds from the user 202 to the resource provider associated with resource provider computer 210. In other embodiments, the transport computer can comprise a merchant gateway server, or any other appropriate computer system used to transmit messages, request messages, and/or authorization request messages to the processing computer 214.

Processing computer 214 (sometimes referred to as a processing server) can comprise a computer system that performs a variety of message and data processing functions. Particularly, processing computer 214 can route data and messages (including request messages and/or authentication request messages) to their intended recipients. As an example, processing computer 214 can identify the intended authorization computer recipient of an authorization request message, and transmit the authorization request message to that authorization computer. Additionally, processing computer 214 can identify that a message (such as an authorization request message) contains superimposed biometric data and transmit that superimposed biometric data to a biometric authentication computer 216 for evaluation. In some embodiments, processing computer 214 may be associated with a payment processing network (such as Visa), and may assist in processing credit and debit card transactions by routing authorization request messages to issuer bank computers.

Biometric authentication computer 216 may comprise a computer system used to authenticate users (such as user 202) based on biometric data, particularly superimposed biometric data generated or determined by user device 204. The biometric authentication computer 216 may have access to a user database 218, which may associate user identifiers and/or user device identifiers, user biometric data, and artificial biometric data assigned to those particular users. Using this data, the biometric authentication computer 216 can verify that received superimposed biometric data “matches” data stored on the user database 218, and thereby authenticate the user. The biometric authentication computer 216 may use a variety of methods (described further below) in order to perform this and other functions.

Upon authenticating the user 202, the biometric authentication computer 216 can transmit an indicator (e.g., to processing computer 214) indicating the status of biometric user authentication. For example, if the user 202 has been successfully authenticated, the biometric authentication computer can transmit an indicator indicating the user's successful authentication. If the user 202 has not been successfully authenticated, the indicator can indicate that the user 202 was not successfully authenticated. The indicator can comprise, for example, binary values, which can be mapped to particular authentication statuses and interpreted by other computers, entities, or devices. For example, an indicator can have a value of 1 or “TRUE” indicating that the user 202 was successfully authenticated or a value of 0 or “FALSE” indicating that the user was not successfully authenticated. As an alternative, the indicator can comprise numerical codes (e.g., “07” corresponding to successful authentication and “13” corresponding to unsuccessful authentication), or descriptive strings, such as “SUCCESS” and “FAILURE.”

The biometric authentication computer 216 can transmit the indicator in order to indicate the biometric authentication status to other computers, devices, and entities in the system 200. The biometric authentication computer 216 can transmit the indicator to the processing computer 214, which can then route the indicator to its intended destination. For example, in a payment processing network, the authorization computer 220 (corresponding to an issuing bank) may benefit from the indicator when determining whether to authorize or deny a transaction. In such a case, the biometric authentication computer 216 can transmit the indicator to the processing computer 216, and the processing computer 216 can include the indicator in an authorization request message transmitted to the authorization computer 220.

The biometric authentication computer 216 can also perform a variety of functions associated with managing user records, accounts, and artificial biometrics. For example, the biometric authentication computer 216 can be used in enrollment process used to enroll the user 202 in the biometric authentication system 200, and can communicate with the user device 204 or the mobile device 206 to accomplish this enrollment. Additionally, the biometric authentication computer 216 can provision artificial biometric data to the user device 204, which the user device 204 can use to generate superimposed biometric data. Further, the biometric authentication computer 216 can track the expiration status of artificial biometric data in the user database 218, and can generate and issue new artificial biometric data if artificial biometric data expires. By assigning expiration dates and replacing expired artificial biometric data, the biometric authentication computer 216 provides greater security; if an identity thief manages to steal artificial biometric data or superimposed biometric data, the stolen data will only be valid for a limited number of time or usages, limiting the damage that the identity thief can cause.

Authorization computer 220 may comprise a computer system that authorizes authorization request messages received from access device 208 via processing computer 214 (or any other communication channel). In transaction processing systems using biometric authentication, authorization computer 220 may comprise an issuer computer associated with an issuing bank, which may have issued the user device 204 (e.g., credit card) to the user 202. The authorization computer 220 may use the contents of any received authorization request messages and an indicator generated by the biometric authentication computer 216 in order to generate authorization response messages. These authorization response messages may indicate whether the user 202 is authorized to perform some action (e.g., complete a transaction) or access some resource. Authorization response messages may be transmitted by the authorization computer 220 back to the access device 208 or resource provider computer 210 via computers or devices in the system 200, such as the processing computer 214. In some use cases, particularly non-transactional use cases, it may not be necessary to have a separate biometric authentication computer 216 and authorization computer 220, and both of these computer systems can be combined into a single computer system.

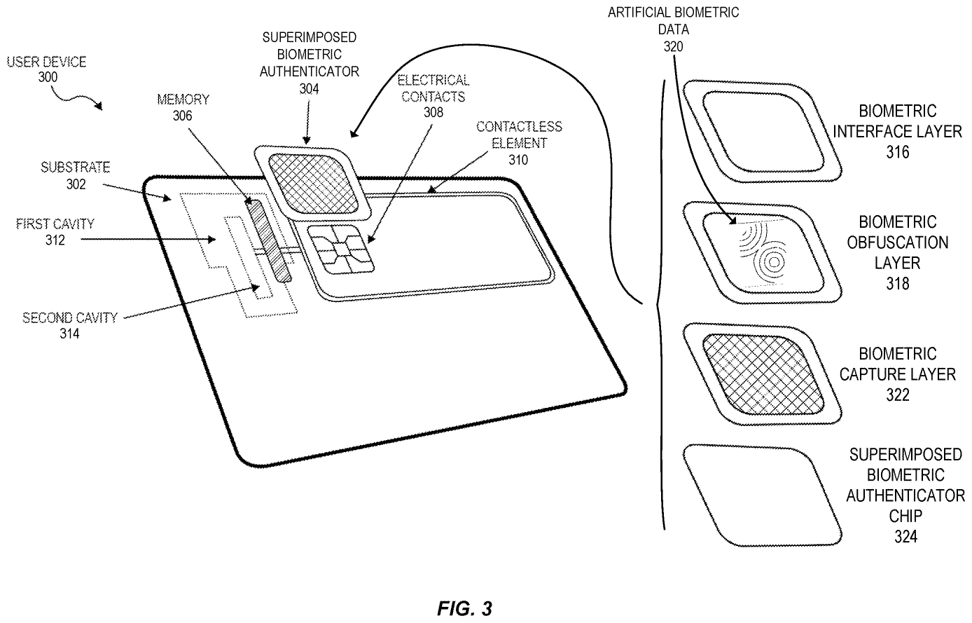

FIG. 3 shows an exploded-view illustration of a smart card user device 300 according to some embodiments. The user device 300 can be largely composed of a substrate 302 (e.g., plastic) in which other components are embedded. These components can include a superimposed biometric authenticator 304, a memory 306, electrical contacts 308 and contactless element 310, which may be referred to more generally as “electrical elements.” The substrate 302 may contain a first cavity 312 and a second cavity 314, which may accommodate the components listed above.

The superimposed biometric authenticator 304 may comprise a multilayered device including a biometric interface layer 316, a biometric obfuscation layer 318, a biometric capture layer 322 and a superimposed biometric authenticator chip 324. In some embodiments, the user device 300 may not have its own power source. As such, the components of the superimposed biometric authenticator 304, including the superimposed biometric authenticator chip 324 may be powered externally, e.g., by a transmission of electrical power from an access device.

The biometric interface layer 316 may comprise a surface which a user can place a biometric source on or in proximity to. Such a biometric source may comprise a user's finger, and the user can place their finger on the biometric interface layer 316 such that their fingerprint is pressed against the biometric interface layer 316. The biometric interface layer 316 may comprise a clear and/or non-conductive surface, such as plastic, glass, quartz crystal, sapphire crystal, etc.

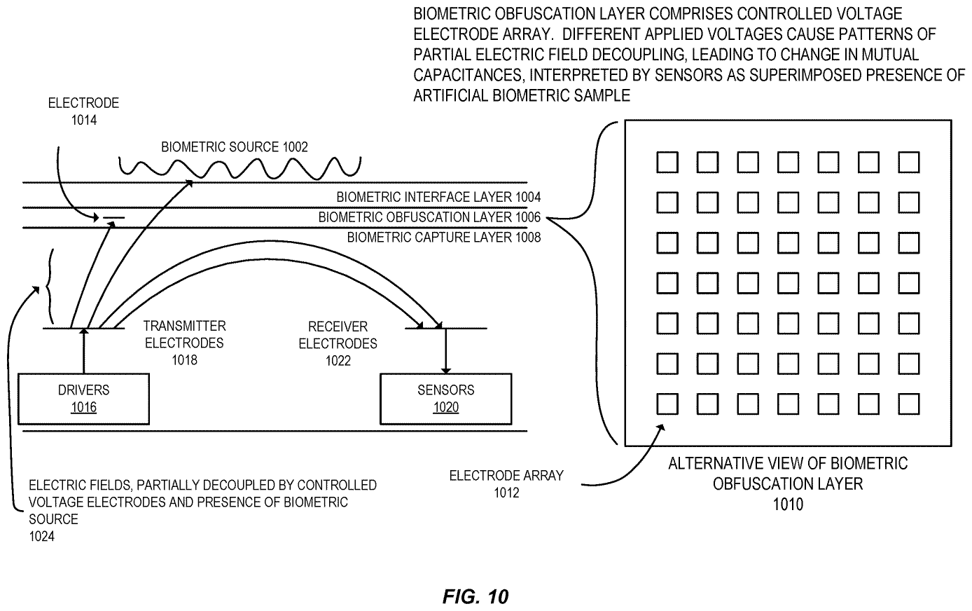

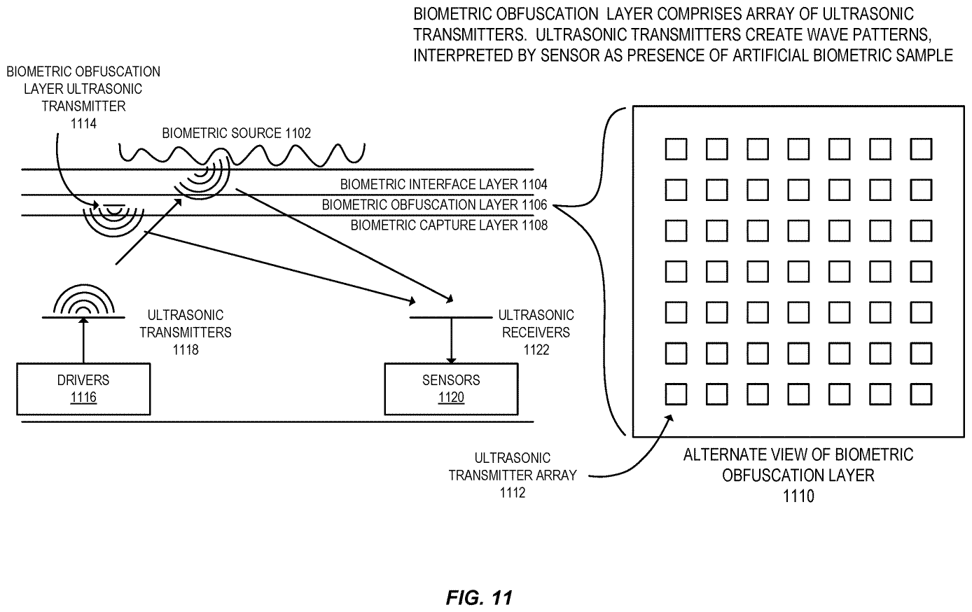

The biometric obfuscation layer 318 may comprise a surface or device on which artificial biometric data 320 (or an artificial biometric sample) can be rendered. As an example, the biometric obfuscation layer 318 can comprise a transparent e-ink display on which an artificial fingerprint can be displayed. Other examples of biometric obfuscation layers are described further below with reference to FIGS. 10 and 11. By rendering artificial biometric data 320 on the biometric obfuscation layer 318, the user device can obfuscate the user biometric source (e.g., a finger placed on the biometric interface layer 316). In some embodiments, the superimposed biometric authenticator chip 324 may digitally combine user biometric data and artificial biometric data stored on the memory 306. In such cases, the biometric obfuscation layer 318 may be optional.

The biometric capture layer 322 may comprise a sensor used to capture biometric samples, particularly superimposed biometric samples resulting from a biometric source placed proximate to the biometric interface layer 316 and artificial biometric data 320 or artificial biometric samples rendered on the biometric obfuscation layer. The biometric capture layer 322 can comprise, for example, an optical, mutual capacitance, or ultrasonic fingerprint scanner.

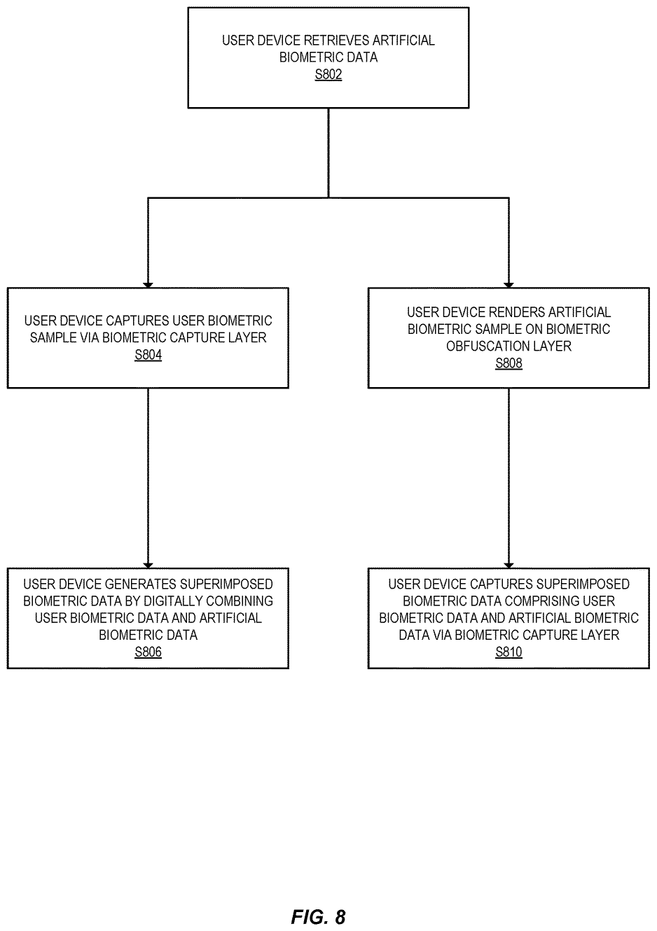

The superimposed biometric authenticator chip 324 can comprise a processor or other device used to perform computing processes associated with generating superimposed biometric data. This can include receiving input from the biometric capture layer 322 and performing a feature extraction process in order to identify relevant or uniquely identifying features from biometric samples, including a superimposed biometric sample. Additionally, as stated above, the superimposed biometric authenticator chip 324 may be used to digitally combine user biometric data and artificial biometric data, as described below with reference to FIGS. 8.

The memory 306 may store instructions or other data which can be interpreted by a processor (e.g., the superimposed biometric authenticator chip) in order to perform some methods according embodiments, relating to the generation of superimposed biometric data for the purpose of authenticating a user of the user device 300, as well as methods for enrolling a user in a biometric authentication system and periodically updating artificial biometric data 320. The memory 306 may additionally contain artificial biometric data 320 received from a biometric authentication computer, which the user device 300 can render on the biometric obfuscation layer 318 or digitally combine with user biometric data to generate superimposed biometric data.

Electrical contacts 308 and contactless element 310 may comprise user device interfaces; means by which the user device 300 can communicate or interface with other devices, such as an access device. Using the electrical contacts 308 and/or contactless element 310, the user device 300 can interface with an access device and transmit superimposed biometric data to a biometric authentication computer via that access device. Further, using the electrical contacts 308 and/or contactless element 310, the user device 300 can receive artificial biometric data 320 from a biometric authentication computer and store that artificial biometric data 320 in the memory 306.

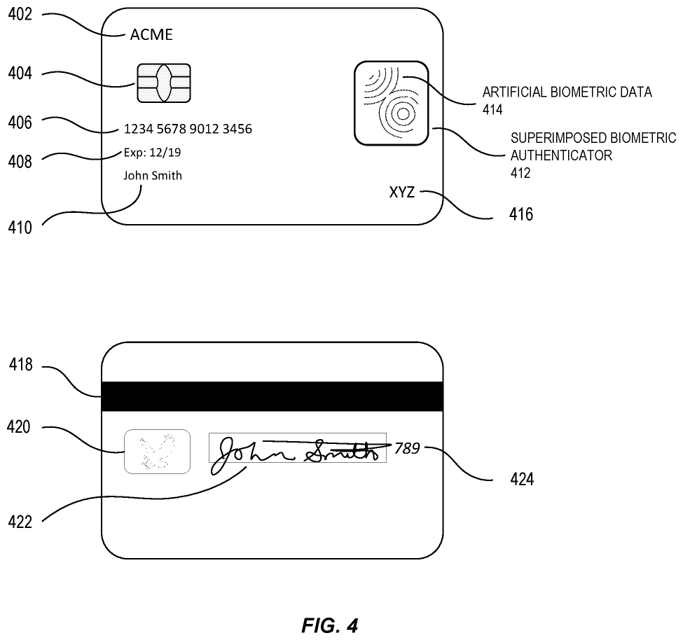

FIG. 4 shows two sides of the exterior view of an exemplary user device according to some embodiments. In FIG. 4, the user device comprises a credit card, which may include an issuer identifier 402 that provides an indication of the authorizing entity backing the user device. In some embodiments, the issuer identifier 402 may include a name or logo of the authorizing entity, which may comprise an issuing bank.

The user device may include an integrated chip circuit 404 (sometimes referred to as a “smart chip”). The surface metal contacts of the integrated chip circuit 404 may serve as a user device interface. Using this interface, the user device can interface with access devices (e.g., point of sale terminals). A user device having an integrated circuit chip may comprise a Europay, Mastercard and Visa (EMV) card. EMV cards can comprise smart cards (also called chip cards or IC cards) that can store their data (e.g., artificial biometric data) on the integrated circuit chip 404 in addition to magnetic stripes (which may provide backwards compatibility). These include cards that are physically inserted (or “dipped”) into a reader or access device and contactless cards that can be read over a short distance using near field communication or radio-frequency identification (RFID) technology. Payment cards that comply with the EMV standard are often called “Chip and PIN” or “Chip and Signature” cards, depending on authentication methods employed by the card issuer. The integrated circuit chip 404 may include a processor or memory that includes preloaded instructions. When powered (e.g., by interfacing with an access device), the processor of the integrated circuit chip 404 may begin executing the preloaded instructions, including generating superimposed biometric data. This memory may also include verification data which, when the integrated circuit chip 404 is powered, may be provided to the access device.

The user device may include a user device identifier 406 (e.g., an account number). The user device identifier 406 may comprise a 15 to 19 digit number. In some embodiments, the user device identifier 406 may be allocated in accordance with International Standard Organization (ISO) standard 7812. In this standard, the leading six digits of the user device identifier 406 may be the “issuer identification number (IIN)”, sometimes referred to as the “bank identification number (BIN).” The remaining numbers of the user device identifier 406, except the last digit, may be the individual account identification number. The last digit is often a check digit (e.g., a Luhn check digit). The IIN or BIN may be used by a processing network to identify an appropriate authorization entity to which transactions using the user device should be routed.

The user device may include an expiration date 408 that indicates a date after which the user device is no longer valid. In some cases, the user may be required to provide the expiration data to complete a transaction. In the event that the user provides an incorrect expiration date, the transaction may be declined. For example, credit card transactions conducted online or over the phone will often require that the user provide the correct expiration date 408 in order to verify that the user is actually in possession of the credit card. These transactions may be declined if the user is not able to provide the correct expiration date.

The user device may include an account holder name 410 that indicates a user or other entity with which the user device is associated. An authorizing entity may maintain an account for the account holder indicated in the account holder name 410. In some embodiments, a transaction may be declined if a name given in association with the account does not match the indicated account holder name 410.

As described above with reference to FIG. 3, the user device may include a superimposed biometric authenticator 412, which may comprise a processor and a number of layers, including a biometric interface layer, a biometric obfuscation layer, a biometric capture layer, and a superimposed biometric authenticator chip. Artificial biometric data 414 or an artificial biometric sample can be rendered on the biometric obfuscation layer in order to obfuscate user biometric data provided by the user. Using the superimposed biometric obfuscator 412, the user device can collect user biometric data from the user and generate superimposed biometric data that can be used to authenticate the user. In some embodiments, the superimposed biometric authenticator 412 can comprise a fingerprint scanner.

The user device may include a processing network indicator 416 that indicates a transaction processing network used to route authorization request messages associated with the user device. In some embodiments, merchant may accept user devices associated with certain processing networks. For example, some merchants may only accept user devices associated with Visa.

The user device may include a magnetic strip 418. The magnetic strip 418 may include up to three tracks, known as track 1, track 2, and track 3. In transactions, only track 1 and track 2 are used. The minimum cardholder account information needed to complete a transaction is present on both tracks. Track 1 has a bit density of 210 bits per inch and is the only track that may contain alphabetic text, and hence is the only track that contains the cardholder's name. Track 2 has a bit density of 75 bits per inch.

The user device may include a hologram 420 or other suitable authentication mechanism. A hologram is a mirror-like section that shows a three dimensional image. Holograms are security features which help merchants identify whether a user device is valid or not. Holograms often require expensive equipment to produce and are used to validate the authenticity of the user device based on the unlikelihood that an unauthorized party would be able to replicate the hologram 420.

The user device may include a signature block 422. In some embodiments, the user device must be signed before it may be used in a transaction. During a transaction, the merchant is often supposed to check the signature of the signature block 422 against the signature provided by a user who signs a receipt for the transaction.

The user device may also include a security code 424. A security code 424 might be a CVV, CVV2, CVC, CSC, CID, or any other suitable security code. In a scenario in which the processing network associated with the user device is Visa, MasterCard, or Discover, the security code 424 can comprise a three digit code on the back of the user device. In a scenario in which the processing network associated with the user device is American Express, the security code 424 can comprise a four digit code located on the front of the card. The security code can be used to verify that a user is in possession of a valid user device.

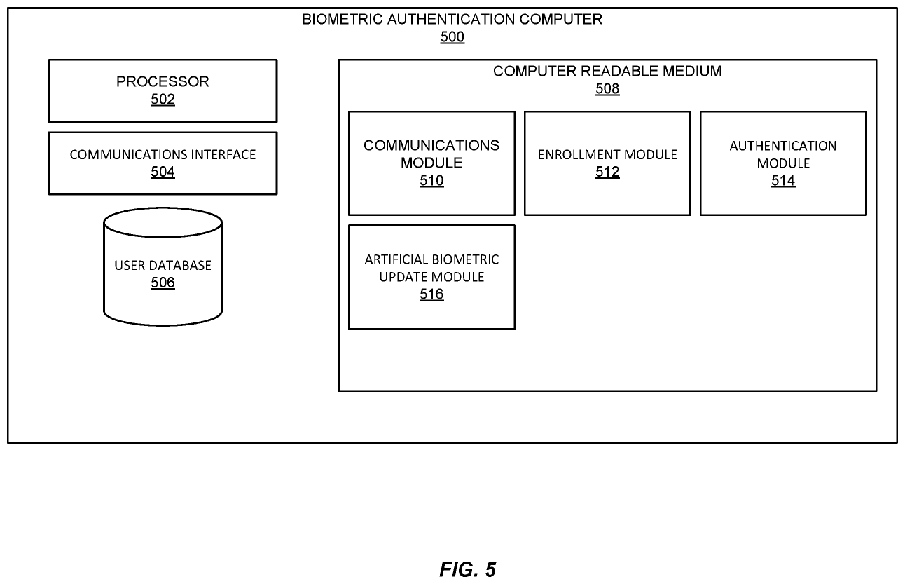

A biometric authentication computer may be better understood with reference to FIG. 5, which shows an exemplary biometric authentication computer 500 comprising a processor 502, a communications interface 504, (optionally) a user database 506, and a computer readable medium 508. The computer readable medium 508 may be non-transitory and coupled to the processor 502. The computer readable medium 508 may contain data, code, and/or software modules, which may be used by the biometric authentication computer 500 to implement some methods according to embodiments. These data, codes, and/or software modules may include a communications module 510, an enrollment module 512, an authentication module 514, and an artificial biometric update module 516. It should be understood that the particular software modules were chosen primarily for the purpose of explaining some methods, steps or operations according to embodiments, and that FIG. 5 shows only one of a large number of valid receiver computer configurations.

Processor 502 may comprise any suitable data computation device or devices. Processor 502 may be able to interpret code and carry out instructions stored on computer readable medium 508. Processor 502 may comprise a Central Processing Unit (CPU) operating on a reduced instructional set, and may comprise a single or multi-core processor. Processor 502 may also include an Arithmetic Logic Unit (ALU) and a cache memory.

Communications interface 504 may comprise any interface by which biometric authentication computer 500 may communicate with other computers or devices. Examples of communication interfaces include wired interfaces, such as USB, Ethernet, or FireWire, as well as wireless interfaces such as Bluetooth or Wi-Fi receivers. Biometric authentication computer 500 may possess multiple communication interfaces. As an example, a biometric authentication computer 500 may communicate through an Ethernet interface as well as a USB port.

The biometric authentication computer 500 can optionally comprise a user database 506, which may store a plurality of user records. These user records may associate user biometric data, artificial biometric data, and user device identifiers. Using the user database 506, the biometric authentication computer 500 can use received user device identifiers in order to identify user biometric data and artificial biometric data. The biometric authentication computer 500 can use this identified biometric data to verify superimposed biometric data received from user devices. In practice, the user database 506 can exist digitally on the computer readable medium 508. Alternatively, the user database 506 can be maintained by an external computer or data system.

Communications module 510 may comprise code, software or instructions that may be interpreted and executed by processor 502. This software may be used by the biometric authentication computer 500 to communicate with other computers, devices, and entities, particularly computers and devices in a network such as the network depicted in FIG. 2. Particularly, the biometric authentication computer 500 can use communications module 510 to receive and interpret messages (including request messages or authorization request messages) comprising user device identifiers and superimposed biometric data. The biometric authentication computer 500 can receive such request messages and/or authorization request messages from an access device interfacing with a user device. Additionally, the biometric authentication computer 500 can use the communications module 510 to transmit indicators and authorization response messages (which may contain indicators) to authorization computers. These indicators may indicate whether a user was successfully biometrically authenticated.

Enrollment module 512 may comprise code, software or instructions that may be interpreted or executed by processor 502. This software may be used by biometric authentication computer 500 to perform steps in an enrollment process used to enroll a user in a superimposed biometric authentication program, thereby enabling the biometric authentication computer 500 to biometrically authenticate users (e.g., using authentication module 514). This enrollment process is described in more detail with reference to FIG. 6. In general, during the enrollment process, the biometric authentication computer 500 can receive and associate user biometric data with a user device identifier in a user record in the user database 506. The biometric authentication computer 500 can additionally use enrollment module 512 to generate artificial biometric data that can be transmitted to a user device, enabling the user device to generate superimposed biometric data using the artificial biometric data. This artificial biometric data can also be associated with the user record in the user database 506, enabling the biometric authentication computer 500 to later biometrically authenticate the user (e.g., using authentication module 514).

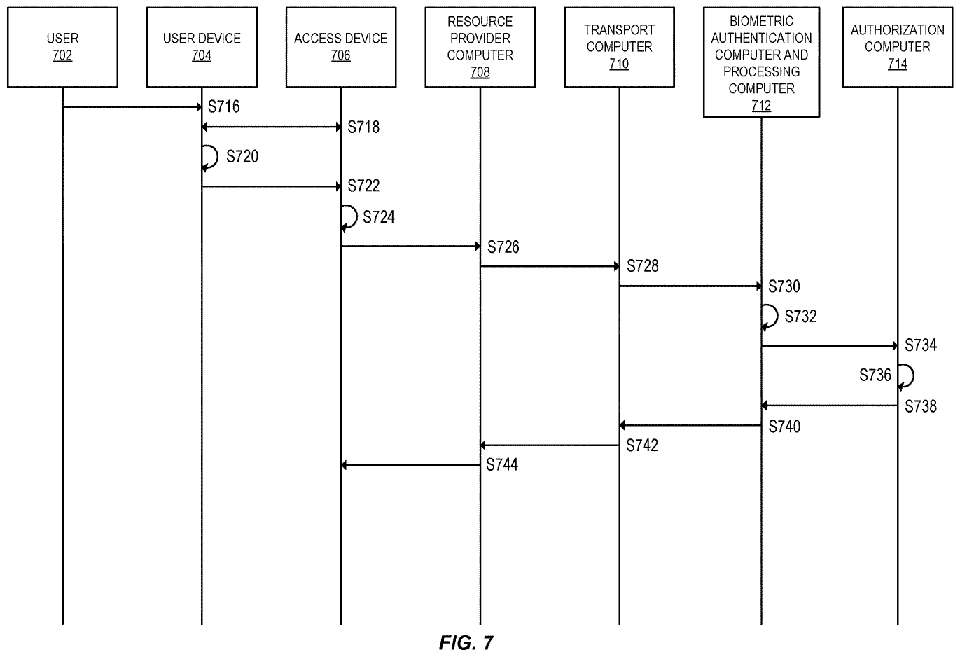

Authentication module 514 may comprise code, software or instructions that may be interpreted or executed by processor 502. This software may be used by biometric authentication computer 500 to perform steps associated with biometrically authenticating a user based on superimposed biometric data received from a user device corresponding to that user. While such authentication processes are described in more detail below, particularly with reference to FIGS. 7 and 9-11, in general terms, the biometric authentication computer 500 can use authentication module 514 to identify user biometric data and artificial biometric data corresponding to a received user device identifier. This biometric data and artificial biometric data can be retrieved from the user database 506. Using the authentication module 514, the biometric authentication computer 500 can verify received superimposed biometric data using the user biometric data and artificial biometric data, thereby verifying that superimposed biometric data corresponds to a user corresponding to a user device (which further corresponds to the user device identifier), thereby biometrically authenticating the user. Additionally, the authentication module 514 can be used by the biometric authentication computer 500 to generate an indicator which can indicate whether any received superimposed biometric was successfully verified. Such an indicator may be useful to an authorization computer, which may authorize some action or interaction (e.g., a transaction) based in part on the indicator.

Artificial biometric update module 516 may comprise code, software or instructions that may be interpreted or executed by processor 502. This software may be used by the biometric authentication computer 500 to update artificial biometric data stored in the user database 506. The biometric authentication computer 500 can use the biometric update module 516 to determine if artificial biometric data has expired or is near expiration, then remove that artificial biometric data from a user record in the user database 506. Afterwards, the biometric authentication computer 500 can use the biometric update module 516 to generate new artificial biometric data, store the new artificial biometric data in a user record in the user database 506, and transmit the new artificial biometric data to a user device. Periodically replacing artificial biometric data provides a security benefit, similar to the security benefit provided by periodically rotating passwords or by expiration dates on credit cards.

Having described systems according to embodiments in detail above, it may be helpful to describe some methods according to embodiments. FIG. 6 depicts a sequence diagram of an onboarding, enrollment, or registration process that can enable superimposed biometric authentication of the user. In general terms, during biometric authentication, the user device 604 can determine superimposed biometric data by combining user biometric data with artificial biometric data. The enrollment process of FIG. 6 is one method by which the user device 604 can receive the artificial biometric data used to determine the superimposed biometric data. Additionally, during biometric authentication, the biometric authentication computer 608 can use user biometric data in order to verify superimposed biometric data received from the user device 604. As such, the enrollment process of FIG. 6 is one method by which the biometric authentication computer 608 can receive the user biometric data.

At step S614, a user can initiate a request to associate user biometric data with a user device 604 via a mobile device authentication application 602 operating on a mobile device (e.g., a smartphone) operated by the user. This mobile device authentication application 602 can have a graphical user interface including, for example, an enrollment button, which may provide a step by step series of instructions that enable the user to complete the enrollment process. The mobile device authentication application 602 may have access to mobile device hardware components, including a built-in biometric scanner.

At step S616, the mobile device operating the authentication application 602 can capture a biometric sample of the user, which can be converted into user biometric data. The user biometric data can comprise a digitized representation of the biometric sample, a biometric template generated by extracting relevant features from the biometric sample, or any other biometric data derived from the biometric sample which can be used to uniquely identify the user. As an example, the user could place a finger on a fingerprint scanner located on the mobile device (e.g., in the screen of a smartphone) and the mobile device can capture the user biometric sample via the fingerprint scanner. As an alternative, the user could place their face in front of a camera located on the mobile device, and the mobile device can capture a user biometric sample comprising a face scan.

At step S618, the mobile device can transmit the user biometric data to a biometric authentication computer 608, for example, over a network such as the Internet. The mobile device authentication application 602 may facilitate this transmission. The mobile device may encrypt the user biometric data (e.g., using a public key corresponding to the biometric authentication computer) before transmitting the user biometric data, in order to safeguard the user biometric data. The mobile device can additionally transmit information such as a username in order to enable the biometric authentication computer 608 to identify the user.

At step S620, the biometric authentication computer 608 may optionally communicate with a user device management computer 612 in order to associate a user device identifier with a user record in a user database (e.g., the user database depicted in FIGS. 2 and 5). If the user does not have an existing user record, the biometric authentication computer 608 may generate a new user record for the user. The user device management computer 612 may be a computer system associated with a service that provisions user devices to users. This may be particularly relevant if the user device 604 comprises a credit card. The user device management computer 612 may be associated with a payment processing network, which stores information (including user device identifiers, e.g., credit card numbers) or otherwise tracks the status of user devices. The biometric authentication computer 608 may query the user device management computer 612 and request a user device identifier associated with any information received from the mobile device authenticator application 602 (e.g., a username), in order to store the user device identifier in the user database in association with the user record.

At step S622, the biometric authentication computer 608 can store the user biometric data in the user database in association with the user record. Storing both the user biometric data and the user device identifier in association with the user record may be useful later, e.g., if biometric authentication computer 608 is being used to biometrically authenticate a user, as it enables the biometric authentication computer to identify relevant user biometric data using a user device identifier.

At step S624, the biometric authentication computer 608 can generate artificial biometric data and stores it in user database in association with user record. The purpose of the artificial biometric data is generally to obfuscate the user biometric data, in order to protect the user biometric data from theft. As depicted in FIG. 1, the artificial biometric data can generally have the same “form” as the user biometric data. For example, if the user biometric data is representative of a fingerprint, the artificial biometric data may also be representative of a fingerprint. The biometric authentication computer 608 could, for example, use a machine learning model trained using real biometric data (e.g., data representing fingerprints) in order to generate artificial biometric data. However, it may not be necessary for the artificial biometric data to match the form of the user biometric data. Randomized data may be sufficient to obfuscate the user biometric data. Consequently, the biometric authentication computer 608 can generate the artificial biometric data using a random number generator or other means of generating randomized data.

At step S626, the user device 604 can receive artificial biometric data generated by the biometric authentication computer 608 during the enrollment process. This artificial biometric data can be encrypted (e.g., with a user device public key) to protect it from any malicious entities that may intercept it during transmission. Afterwards, at step S628, the user device 604 can store the artificial biometric data in a memory element. FIG. 6 shows the user device 604 receiving the artificial biometric data from the biometric authentication computer 608 via an access device 606. This may occur if the user device 604 comprises a device such as a smartcard. Typically smartcards cannot communicate over networks such as the Internet without an access device 606 (e.g., a smartcard reader). As such, it may not be possible for the smartcard to receive the artificial biometric data without an access device 606.

As an example real world use case, if the user device 604 comprises a (smart) credit card, the user could interface the credit card with an ATM access device 606 (e.g., by inserting it into a card slot in the ATM), then initiate the enrollment process using the mobile device authenticator application 602 on their mobile device. The enrollment steps can proceed as outlined above. At step S626, the biometric authentication computer 608 can transmit the artificial biometric data to the ATM, which can transmit the artificial biometric data to the credit card via the card slot. The credit card can then load the artificial biometric data in a memory element, e.g., a memory element embedded in the substrate of the credit card, as depicted in FIG. 3.

In other embodiments, the user device 604 may comprise a device such as a smartphone, laptop, tablet, etc., which may be able to communicate over networks such as the Internet without the use of a dedicate access device 606. In such cases, the biometric authentication computer 608 can transmit the artificial biometric data to the user device 604 directly. Moreover, in some embodiments, the user device 604 and the mobile device operating the mobile device authentication application 602 may comprise a single device. In such a case, the biometric authentication computer 608 may transmit the artificial biometric data back to the mobile device, and the mobile device authentication application 602 may interpret and decrypt the received artificial biometric data, then cause the mobile device to store the artificial biometric data in a memory element.

Having described an enrollment process in some detail, it may now be appropriate to describe a process or method by which a user can be biometrically authenticated using superimposed biometric data. FIG. 7 shows a sequence diagram of an exemplary method. In FIG. 7, the processing computer and biometric authentication computer have been combined into a single box in order to fit the entire sequence diagram into a single figure.

At step S716, the user 702 can initiate the biometric authentication process using their user device 704. A variety of factors influence what this step entails, including the particular biometrics being used for authentication and the form of the user device. Generally however, the user 702 can initiate the biometric authentication process by placing a biometric source in proximity to a superimposed biometric authenticator located on the user device 704. As an example, for a smartcard user device 704 used to authenticate the user 702 using fingerprint biometrics, the user 702 may initiate authentication by placing their finger or thumb on a superimposed biometric authenticator located on the smartcard. As another example, for a smartphone user device 704 used to authenticate the user 702 using facial scan biometrics, the user 702 may initiate authentication by activating an application on their smartphone and placing their face in view of a camera located on the smartphone.

At step S718, the user device 704 can interface with the access device 706. The nature of this interfacing process can depend on the form of the user device 704 and access device 706. In some embodiments, the user device 704 interfaces with the access device 706 via near field communication or by establishing physical contact between a user device interface and an access device interface. As an example, the user device interface could comprise surface metal contacts, such as those on EMV enabled credit cards. A POS terminal access device 706 could include its own surface metal contacts, by touching these two contacts to each other, data can be transmitted electronically between the two devices. For a user device 704 comprising a smartphone, physical contact could be achieved by bridging the user device 704 and access device 706 using a cable, such as a micro USB cable. However, generally for a smartphone user device 704 capable of wireless communication, wireless communication methods such as near field communication may be more appropriate.

In some cases, the user device 704 interfacing with the access device 706 may involve the user device 704 receiving a transmission of electrical power from the access device 706. This may be relevant if the user device 704 does not have any onboard power source. Many near field communication enabled smartcards, for example, rely on electromagnetic power from near field communication readers to power their circuitry. This transmission of electrical power may power a biometric capture layer located in the user device 704, which may be used to determine superimposed biometric data (as described in step S720). As stated throughout this disclosure, this superimposed biometric data can be used to authenticate the user 702, e.g., at step S732.

At step S720, the user device 704 can determine superimposed biometric data comprising a combination of user biometric data and artificial biometric data. The user biometric data can be derived from a biometric sample captured by a superimposed biometric authenticator located on the user device 704. The biometric sample can comprise a fingerprint which was captured from a biometric source, which can comprise (for example) a finger corresponding to the user 702 (i.e., one of the user's 702 fingers). As an alternative, the biometric sample can comprise an iris scan which was captured from a biometric source comprising one or both of the user's 702 eyes.

In some embodiments, the step of interfacing (S718) can occur after determining the superimposed biometric data, and therefore step S720 can be performed prior to performing step S718. In some embodiments, prior to performing biometric authentication, the user device 704 may undergo an enrollment, onboarding, or registration process (as described above with reference to FIG. 6). Consequently, prior to determining the superimposed biometric data, the user device 704 may receive artificial biometric data from the biometric authentication computer 712. The user device 704 may store the received artificial biometric data in a memory element. The biometric authentication computer 712 may have generated the artificial biometric data during the enrollment process.

In some embodiments, the user device 704 can determine the superimposed biometric using one of two example methods, which are summarized by the flowchart of FIG. 8. At step S802, the user device can retrieve the artificial biometric data, e.g., from a memory element in the user device. Then the user device can proceed to either step S804 or step S808 depending on which method the user device is using to combine the artificial biometric data and the user biometric data.

If the user device is combining the artificial biometric data and user biometric data using a digital combination, the user device can proceed to step S804. In a digital combination, the user device first captures a biometric sample of the user via a biometric capture layer (which can be part of a superimposed biometric authenticator located on the user device, as described above with reference to FIG. 3). The user device can process the biometric sample to generate user biometric data, e.g., by extracting any relevant or identifying features from the biometric sample.

At step S806, the user device can digitally combine the user biometric data and the artificial biometric data, thereby determining the superimposed biometric data. A variety of digital combination methods can be used depending on how the biometric data and artificial biometric data is digitally represented in the user device. For example, if the biometric data and artificial biometric data are represented as vectors or arrays of numerical values, elementwise operations can be performed to combine the biometric data and artificial biometric data. As examples, each numerical element of biometric data can be summed with a corresponding numerical element of artificial biometric data to digitally combine the user biometric data and artificial biometric data. Alternatively, each numerical element of biometric data can be averaged with a corresponding element of artificial biometric data, thereby digitally combining the user biometric data and artificial biometric data to generate the superimposed biometric data.

An advantage of digital combination is it typically requires less specialized hardware than the “superimposed combination” methods described below. However, the user biometric data is slightly more vulnerable because it exists (if only briefly) in some form in user device memory prior to mixing. The superimposed combination techniques do not have this vulnerability, but require specialized biometric capture hardware.

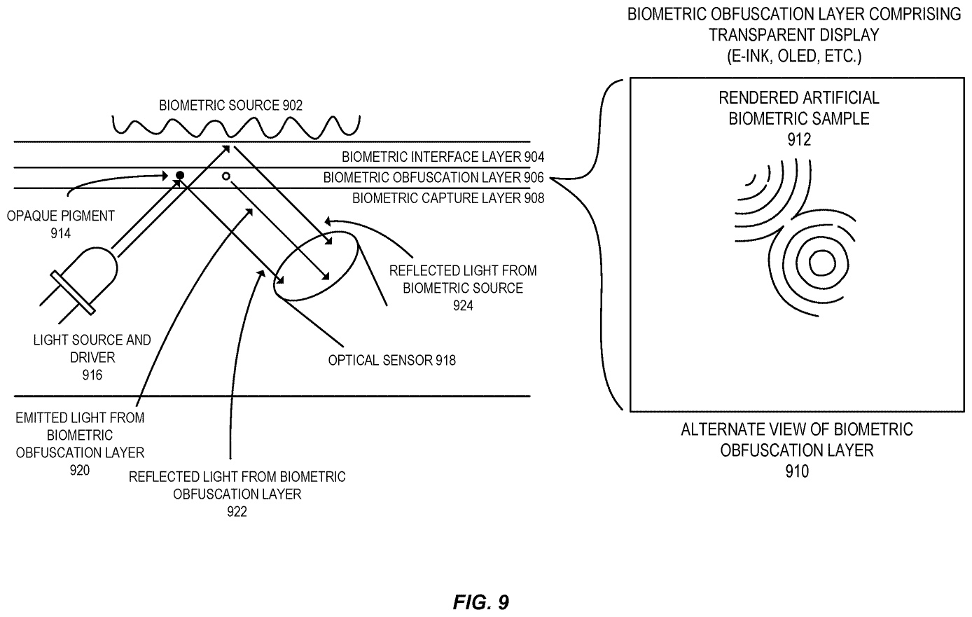

If the user device is generating the superimposed biometric data using superimposed combination techniques, the user device can proceed to step S808 rather than step S804. At step S808, the user device can render an artificial biometric sample on a biometric obfuscation layer (e.g., as depicted in FIG. 3). The biometric obfuscation layer can be located between a biometric capture layer (e.g., a fingerprint scanner) and a biometric source (e.g., the user's finger). Rendering the artificial biometric sample on the biometric obfuscation layer depends in large part on the technology used to perform the biometric capture (e.g., optical, capacitive, ultrasonic, etc.) As such, specific details on this rendering process are described in more detail with reference to FIGS. 9-11.

At step S810 the user device can capture a superimposed biometric sample comprising a combination of the artificial biometric sample rendered on the biometric obfuscation layer (i.e., at step S808) and a biometric sample of the user (e.g., a fingerprint). The user device can then determine the superimposed biometric data, for example, by performing a feature extraction process or otherwise converting the superimposed biometric sample to a digital representation. The nature of this capture process depends in large part on the technology and biometric capture layer used to capture biometric samples, which is described for three common fingerprint scanning technologies (i.e., optical, mutual capacitive, and ultrasonic) in the following paragraphs. The advantage of using superimposed mixing (as opposed to digital mixing), is that a biometric sensing apparatus located in the user device can capture the superimposed combination of a user biometric sample and an artificial biometric sample prior to digitization and generating the superimposed biometric data. As a result, user biometric data does not exist in the user device in memory at any point, reducing the probability that it is stolen and thereby improving security. However, as described in the following paragraphs, this superimposed combination technique requires novel modifications to biometric imaging apparatuses.

FIG. 9 shows a cross section of an exemplary superimposed biometric authenticator configuration using optical scanning technology. Such an authenticator can be integrated into a user device. For example, this superimposed biometric authenticator can be integrated into the screen of a smartphone. As another example this superimposed biometric authenticator can be integrated into the substrate of a smartcard user device, e.g., as depicted in FIG. 3. The exemplary superimposed biometric authenticator of FIG. 9 comprises an optical fingerprint scanner modified to include a biometric obfuscation layer 906, which enables the user device to use superimposed combination techniques to determine the superimposed biometric data.

To begin the process to determine the superimposed biometric data, the user can place a biometric source 902, such as a finger, on the biometric interface layer 904, which may comprise a transparent material such as plastic, glass, quartz crystal, sapphire crystal, etc. As a result, the user's fingerprint ridges may be incident to the biometric interface layer 904. Responsive to this placement, the superimposed biometric authenticator may begin the process to capture the superimposed biometric data. For example, the optical sensor 918 may be triggered by a change in ambient input light due to the shadow caused by biometric source 902. As another example, pressure applied by the biometric source 902 to the biometric interface layer 904 can trigger a pressure sensor (not shown) which may activate the components in FIG. 9 to begin the process for determining the superimposed biometric data.

In a conventional optical fingerprint scanner, a light source (e.g., an LED, flashlight, etc.) and driver can be used to illuminate fingerprint ridges. The fingerprint ridges can re-emit or reflect light into an optical sensor (e.g., a camera). The optical sensor 918 can transduce the reflected light into a digital image. From this image, a feature extraction process can be performed, resulting in biometric data that can be used to authenticate the user.

However, unlike a conventional optical fingerprint scanning system, the system of FIG. 9 includes a biometric obfuscation layer 906. In some embodiments, the biometric obfuscation layer can comprise a transparent display, such as a transparent e-ink or OLED display. As depicted in the alternate view of the biometric obfuscation layer 910, the user device can render an artificial biometric sample 912 (e.g., a fake fingerprint) on the biometric obfuscation layer 906 by displaying the artificial biometric sample 912 on the transparent display. Depending on the technology used, either reflected light 922 from opaque pigments 914 in the biometric obfuscation layer 906 (e.g., from a transparent e-ink display) or emitted light 920 in the biometric obfuscation layer 902 (e.g., from a transparent OLED display) can enter the biometric capture layer 908, which can comprise an optical sensor 918. Light from either of these potential sources can strike the optical sensor 918. The combination of the emitted light 920 or the reflected light 922, and the reflected light 924 from the user's biometric source 902 (produced, e.g., by the light source and driver 916) can be transduced by the optical sensor 918 as a superimposition of the rendered artificial biometric sample 912 and a user biometric sample. From this superimposition, a feature extraction process can be performed, resulting in superimposed biometric data which can later be used by the biometric authentication computer to authenticate the user.

Embodiments of the present disclosure can also be practiced using different biometric scanning technologies, such as mutual capacitance scanning. FIG. 10 shows another cross section of an exemplary superimposed biometric authenticator configured to use mutual capacitance technology. As with the superimposed biometric authenticator of FIG. 9, this superimposed biometric authenticator can be integrated into a user device, e.g., in the screen of a smartphone or embedded into the substrate of a smart card. The exemplary superimposed biometric authenticator of FIG. 10 comprises a mutual capacitance sensor array modified to include a biometric obfuscation layer 1006, which enables the user device to use superimposed combination techniques to determine the superimposed biometric data.

To begin the process to determine the superimposed biometric data, the user can place a biometric source 1002, such as a finger, on the biometric interface layer 1004, which may comprise a dielectric material, such as a layer of aluminum oxide coated with a layer of epoxy-siloxane. As a result, the user's fingerprint ridges may be incident to the biometric interface layer 1004. Responsive to this placement, the superimposed biometric authenticator may begin a process to capture the superimposed biometric data. For example, an array of mutual capacitance sensors 1020 may be triggered by a change in capacitance triggered by the proximity of the biometric source 1002.

In a conventional mutual capacitance fingerprint scanning system, a 2D array of transmitter electrodes can be driven by an array of drivers. The drivers can drive the electrode using e.g., voltage pulses. Each transmitter electrode has mutual capacitance with a corresponding receiver electrode in a receiver electrode array. Each receiver electrode can be connected to a corresponding sensor. The mutual capacitance between any transmitter electrode and its corresponding receiver electrode is proportionate to the electric field coupling between the transmitter electrode and the receiver electrode. The electric fields between these electrodes exists as a result of the voltage difference between the transmitter electrodes and their corresponding receiver electrodes, which is a consequence of the voltage produced by the drivers. The sensors can be used to measure this mutual capacitance.

As a biometric source (such as a user's finger) enters the electric fields, it provides a path through the user's body to earth ground. This causes partial decoupling of the electric fields, which reduces the mutual capacitance between the transmitter electrodes and the receiver electrodes. This reduction in mutual capacitance can be picked up by the sensors. Provided the transmitter and receiver electrode arrays have high enough resolution (e.g., a large number of electrodes spaced closely together), the difference in mutual capacitance between, for example, a fingerprint ridge and a fingerprint valley in a fingerprint can be detected. As such, a fingerprint can effectively be “imaged” by the sensors based on local differences in mutual capacitance. Feature extraction can be performed on this image to convert it into user biometric data which can be used to authenticate a user.

However, unlike a conventional mutual capacitance fingerprint scanning system, the system of FIG. 10 can additionally comprise a biometric obfuscation layer 1006. As shown in the alternative view of the biometric obfuscation layer 1010, in some embodiments, the biometric obfuscation layer 1006 can comprise an electrode array comprising a plurality of electrodes, such as electrode 1014. The user device can render an artificial biometric sample (e.g., a fake fingerprint) on the biometric obfuscation layer 1106 by manipulating a plurality of voltages corresponding to the plurality of electrodes, e.g., by applying different voltages to different electrodes.

In FIG. 10, the biometric capture layer 1008 can comprise a mutual capacitance sensor array, including a plurality of transmitter electrodes 1018 and a plurality of receiver electrodes, which may be paired and/or organized in a grid. The transmitter electrodes 1018 can be driven by voltage drivers. The potential difference between the transmitter electrodes 1018 and their corresponding receiver electrodes 1022 can cause electric fields 1024 to form. Sensors 1020 can measure these electric fields 1024 and measure or calculate any effects of these fields (e.g., changing capacitance). The electric field coupling between the transmitter electrodes 1018 and receiver electrodes 1022 is affected by the presence of the biometric source 1002, causing a change in the mutual capacitance, which can result in the sensors 1020 “imaging” the biometric source 1002. The electric fields 1024 can be further decoupled by the presence of the electrode array 1012 located in the biometric obfuscation layer 1006. Because the electric field coupling between the transmitter electrodes 1018 and the electrode array 1012 is dependent on the voltage difference between the transmitter electrodes 1018 and the electrode array 1012, and because the voltages of each electrode in the electrode array 1012 are controlled by the user device, the user device can effectively render an artificial biometric sample on the biometric obfuscation layer 1006, which can be detected by the sensors 1020 in the mutual capacitance sensor array. The sensors 1020 can therefore “image” a superimposed combination of a user biometric sample (derived from the biometric source 1002) and an artificial biometric sample rendered on the biometric obfuscation layer. The user device can interpret (e.g., feature extract) the superimposed combination to determine the superimposed biometric data.

Other technologies, such as ultrasonic scanning can also be practiced with embodiments of the present disclosure. FIG. 11 shows another cross section of an exemplary superimposed biometric authenticator configured to use ultrasonic scanning technology. As with the superimposed biometric authenticators of FIGS. 9 and 10, this superimposed biometric authenticator can be integrated into a user device such as a smartphone or smartcard. The exemplary superimposed biometric authenticator of FIG. 11 comprises an ultrasonic sensor modified to include a biometric obfuscation layer 1106, which enables the user device to use superimposed combination techniques to determine the superimposed biometric data.

To begin the process to determine the superimposed biometric data, the user can place a biometric source 1102, such as a finger, on the biometric interface layer 1104, which may comprise a material such as plastic, glass, quartz crystal, sapphire crystal, or any other material through which ultrasonic waves can propagate. As a result, the user's fingerprint ridges may be incident to the biometric interface layer 1104. Responsive to this placement, the superimposed biometric authenticator may begin a process to capture the superimposed biometric data. For example, a pressure sensor may activate the superimposed biometric authenticator in response to the incident pressure applied by the biometric source 1102.

In a conventional ultrasonic fingerprint scanner, an array of ultrasonic transmitters may be driven by drivers to produce ultrasonic waves. These ultrasonic waves can reflect off the biometric source 1102 and return to ultrasonic receivers and sensors (e.g., microphones, vibration sensors, pressure sensors, mechanical stress sensors, etc.). Variations in the returned ultrasonic waves, corresponding to variations in the structure of the biometric source 1102 (e.g., fingerprint ridges and valleys) can be detected by the sensors and used to “image” the biometric source 1102. This “image” can be converted into user biometric data which can be used to authenticate the user.

However, unlike a conventional ultrasonic fingerprint scanner, the system of FIG. 11 can additionally comprise a biometric obfuscation layer 1106. As shown in the alternate view of the biometric obfuscation layer 1110, the biometric obfuscation layer 1106 can comprise an ultrasonic transmitter array 1112 comprising a plurality of ultrasonic transmitters, such as ultrasonic transmitter 1114. The user device can render an artificial biometric sample (e.g., a fake fingerprint) on the biometric obfuscation layer 1106 by driving the plurality of ultrasonic transmitters, thereby generating a plurality of ultrasonic waves corresponding to the artificial biometric sample. In effect, the user device can use the biometric obfuscation layer 1106 to generate ultrasonic waves that would be reflected off a hypothetical artificial biometric source placed on the biometric interface layer 1104.

An array of drivers 1116 can drive an array of ultrasonic transmitters 1118 to produce ultrasonic waves that reflect off the biometric source 1102. These reflected ultrasonic waves, along with any ultrasonic waves produced by the biometric obfuscation layer 1106 can be received by an array of ultrasonic receivers 1122 and measured or interpreted by the sensors 1120. The result can comprise a superimposed combination of a user biometric sample (produced by the biometric source 1102) and an artificial biometric sample (produced by the biometric obfuscation layer 1106). The result can be interpreted (e.g., feature extracted) as superimposed biometric data, and later used by a biometric authentication computer to authenticate the user.

It should be understood that FIGS. 9-11 and the description above are intended to summarize possible methods for superimposed combination of user biometric data and artificial biometric data using novel modifications of currently available biometric scanning technologies (i.e., optical, mutual capacitive, and ultrasonic). The description and FIGS. 9-11 are not intended to limit methods according to embodiments to these biometric imaging technologies. Other biometric imaging technologies can be similarly modified to include a biometric obfuscation layer for the purpose of enabling superimposed biometric combination as described above.

Referring back to FIG. 7, after determining the superimposed biometric data, the user device 704 can transmit the superimposed biometric data and a user device identifier (corresponding to the user device 704) to the biometric authentication computer 712. The user device identifier could comprise, as examples, a credit card number (for a credit card user device 704) or a SIM number (for a smartphone user device 704). Transmitting the user device identifier along with the superimposed biometric data can enable the biometric authentication computer 712 to verify that the superimposed biometric data corresponds to the user 702 corresponding to the user device 704 (e.g., the owner or operator of the user device 704) using the superimposed biometric data and the user device identifier. For example, as described below with reference to step S732, the biometric authentication computer 712 can use the user device identifier to identify a user record in a user database. This user record may contain user biometric data and artificial biometric data that can be used by the biometric authentication computer 712 to verify the superimposed biometric data.

In some embodiments, the user device 704 can transmit the superimposed biometric data and user device identifier somewhat directly (e.g., via a network such as the Internet) to the biometric authentication computer 712. However, in other embodiments, the biometric authentication system may be part of a broader system, such as a four-party network used to process payment transactions. In such a case, the superimposed biometric data and the user device identifier may be transmitted through a series of intermediary computers and devices before reading the biometric authentication computer 712.

This sequence of transmissions is generally depicted in steps S722-S730. At step S722, the user device 704 can transmit the superimposed biometric data and user device identifier to the access device 706 (such that the biometric authentication computer 712 eventually receives the superimposed biometric data and user device identifier via the access device 706). This transmission can be performed via the interface established at step S718. For example, if the user device 704 comprises a near field communication enabled credit card, the user device 704 can communicate with the access device 706 (e.g., a point of sale terminal) via a near field communication channel established between the user device 704 and the access device 706 at step S718.

In some embodiments, particularly if the biometric authentication system is used to authenticate users in order to authorize payment transactions, at step S724 the access device can generate a request message or “authorization request message.” Such messages can be used in payment card transactions to request authorization for a transaction. Typically, credit card and transaction information (e.g., transaction amount, merchant name or identifier, time of transaction, credit card number, card verification value (CVV), expiration date, etc.) is included in the authorization request message and routed to an issuing bank via a payment processing network (which can include a processing computer as depicted in the figures) such as Visa. An authorization computer 714, operated by the issuing bank, can evaluate the authorization request message and generate an authorization response message (e.g., at step S736), which can be routed back to the access device 706 in order to indicate whether the transaction is approved or denied.

In some embodiments, the access device 706 can additionally include the superimposed biometric data and the user device identifier in the authorization request message. This can enable a biometric authentication computer 712 (which may be associated with the processing computer and the processing network) to biometrically authenticate the user 702. In doing so, the biometric authentication computer 712 can determine if a legitimate user 702 is using the user device 704 to make a purchase, which may be useful information for the authorization computer 714 when it determines whether to authorize or deny the transaction.

At step S726, the access device 706 can transmit the request message or authorization request message to a resource provider computer 708, which can comprise a computer system associated with a merchant operating the access device 706 (e.g., a computer connected to a point of sale terminal). At step S728, the resource provider computer 708 can subsequently send the request message or authorization request message to a transport computer 710. The transport computer 710 can comprise a computer system associated with an acquirer bank that maintains a payment account for the merchant. Subsequently at step S730, the transport computer 710 can transmit the request message or authorization request message to a processing computer.

As stated above, the processing computer can comprise a server computer that is part of a processing network, which may process large amounts of payment card transactions regularly. One function of the processing computer can comprise identifying acquirer banks and issuer banks and their respective computer systems (e.g., the transport computer 710 and the authorization computer 714). After identifying their intended recipients, the processing computer can forward authorization request messages to the corresponding authorization computers for authorization. In doing so, the processing computer can enable a transfer of funds from an account corresponding to the user 702 to an account corresponding to a resource provider, thereby enabling users and resource providers to complete transactions.

In performing this function, the processing computer may analyze authorization request messages and use information contained therein to identify relevant authorization computers (and transport computers). For example, for a user device identifier comprising a credit card number, the first few digits of the user device identifier may comprise a “bank identification number” (BIN), which may identify an issuer bank, enabling the processing computer to route the authorization request message to an authorization computer associated with that issuing bank. In embodiments of the present disclosure, the processing computer can further evaluate the authorization request message (received from the transport computer 710) to determine if it contains superimposed biometric data.

If the authorization request message includes superimposed biometric data, the processing computer can transmit the request message or authorization request message comprising the user device identifier and superimposed biometric data to the biometric authentication computer 712. Alternatively, the processing computer can transmit just the user device identifier and superimposed biometric data to the biometric authentication computer, without the rest of the information included in the request message or authorization request message, as that additional information may not be necessary for biometrically authenticating the user 702.

At step S732, the biometric authentication computer 712 can authenticate the user using the superimposed biometric data. To do this, the biometric authentication computer 712 can compare the received superimposed biometric data to user biometric data and artificial biometric data corresponding to user 702. Such data can be stored in a user database, e.g., user database 218 from FIG. 2.

The biometric authentication computer 712 can identify user biometric data and artificial biometric data corresponding to a user device identifier (which can be included in the request message transmitted to the biometric authentication computer 712). As described above, this user device identifier could comprise a credit card number (for credit card user devices), a SIM card number (for smartphone user devices) or any other appropriate identification number. In a user database, biometric data and artificial biometric data correspond to users may be stored in association with corresponding user device identifiers. As such, the biometric authentication computer 712 can identify such data by, for example, querying the user database using the user device identifier.

After identifying the user biometric data and artificial biometric data corresponding to the user device identifier, the biometric authentication computer 712 can then verify the superimposed biometric data using the user biometric data and the artificial biometric data. Thereby, the biometric authentication computer 712 verifies that the superimposed biometric data corresponds to the user 702 corresponding to the user device 704, further corresponding to the user device identifier. Afterwards, the biometric authentication computer 712 can generate an indicator, which can indicate whether the superimposed biometric data was successfully verified. The indicator can comprise, for example, a binary value, for which a value of 1 (TRUE) can be interpreted as a successful verification and a value of 0 (FALSE) can be interpreted as unsuccessful verification. As another example, the indicator can comprise a short string, such as “SUCCESS” or “FAILURE” to indicate whether the superimposed biometric data was successfully verified or not.

There are a number of techniques that the biometric authentication computer 712 can employ to verify the superimposed biometric data using the user biometric data and artificial biometric data. Three examples are provided below. These example can be broadly categorized as either “additive” techniques or “subtractive” techniques. In additive techniques, the biometric authentication computer 712 can combine the identified user biometric data and artificial biometric data to generate second superimposed biometric data, and compare that with the superimposed biometric data received at step S730. If they match, the superimposed biometric data has been successfully verified. In subtractive techniques, the biometric authentication computer 712 can attempt to “subtract” or “uncombine” the artificial biometric data or the user biometric data from the received superimposed biometric data, and thereby generate either second user biometric data (when the artificial biometric data is “subtracted”) or second artificial biometric data (when the user biometric data is “subtracted”) which can then be compared to the respective biometric data identified by the user device.

Referring now to FIG. 12, which shows a description of an “additive” comparison technique. As described above with reference to FIG. 7, at step S1202, the biometric authentication computer can identify user biometric data and artificial biometric data corresponding to the user device identifier. This can be accomplished by querying a user database using the user device identifier, or otherwise “looking up” the user biometric data and artificial biometric data in the user database.

At step S1204, the biometric authentication computer can generate second superimposed biometric data by combining the user biometric data and the artificial biometric data. This can be accomplished in a variety of ways. Often, digital data is represented by numeric arrays. As an example, images often comprise numerical arrays of color values, which can be interpreted by a computer to render an image on a display. Biometric data can likewise be represented by numeric arrays. If the user biometric data and the artificial biometric data comprise equally sized numeric arrays, they can be combined by adding (or averaging) each array value with the corresponding array value from the other array, thereby creating second superimposed biometric data that comprises a combination of the user biometric data and the artificial biometric data. The above is intended only as a non-limiting example, there are a large variety of ways to combine two data groups (i.e., the user biometric data and the artificial biometric data) which depend in large part on the structure or form of such data.

At step S1206, the biometric authentication computer can compare the superimposed biometric data to the second superimposed biometric data and authenticate the user if they match. As described above, the biometric authentication computer can generate an indicator to that effect, i.e., indicating whether the superimposed biometric data was successfully verified and the user successfully authenticated.

Due to a variety of factors, the superimposed biometric received from the user device often will not exactly match the second superimposed biometric generated by the biometric authentication computer. As one example, for a fingerprint biometric, it is unlikely that a user will place their finger or thumb at the exact correct position or angle, such that it perfectly matches the user biometric data stored in the user database. Likewise, for a biometric that comprises a retina scan, the distance between the user's eye and the user device biometric interface, the characteristics of the light in the room, and other miscellaneous factors can affect the resulting superimposed biometric data. Consequently, the biometric authentication computer can use approximate or threshold biometric data matching techniques, as summarized in broad detail below.

The biometric authentication computer can determine a similarity (sometimes referred to as a similarity score or similarity measure) between the second superimposed biometric data and the superimposed biometric data. The biometric authentication computer can use similarity metrics such as the cosine similarity or the Jaccard index (which is sometimes referred to as the Tanimoto index). However, it is likely that better results can be achieved using a problem specific similarity metric, which may depend wholly or in part on the nature of the biometric data under analysis (e.g., a different similarity metric may be appropriate for fingerprint biometric data than for facial scan biometric data).

After determining the similarity, the biometric authentication computer can verify the superimposed biometric data based on the similarity and a predetermined threshold. The predetermined threshold may be determined wholly or in part based on the nature of the similarity or similarity measure being used. For example, the Jaccard index typically takes a value from 0-1, which means a predetermined threshold such as 0.9 may be appropriate. By contrast, the Euclidean distance can extend from zero to infinity, and consequently a different predetermined threshold may be appropriate.

The biometric authentication computer can verify the superimposed biometric data by comparing the similarity to the predetermined threshold, e.g., by determining whether the similarity is greater than or less than the predetermined threshold. For similarities such as the Jaccard index, two data sets (e.g., the superimposed biometric data and the second superimposed biometric data) are more similar the higher the Jaccard index is, being identical when the Jaccard index equals one. Consequently, when using the Jaccard index, the biometric authentication computer could verify that the similarity is greater than or equal to the predetermined threshold, which can comprise a successful biometric authentication, whereas a similarity less than the predetermined threshold can comprise an unsuccessful biometric authentication.

However, for other similarities, such as the Euclidean distance, two data sets are more similar the lower the Euclidean distance is, being identical when the Euclidean distance is zero. Consequently, when using the Euclidean distance, the biometric authentication compare could verify that the similarity is less than or equal to the predetermined threshold, which can comprise a successful biometric authentication, whereas a similarity greater than the predetermined threshold can comprise an unsuccessful biometric authentication.

In this way, the biometric authentication computer can verify the superimposed biometric data using the user biometric data and the artificial biometric data, thereby verifying that the superimposed biometric data corresponds to a user corresponding to a user device, which itself corresponds to the user device identifier. The biometric authentication computer can generate an indicator, which can indicate whether the superimposed biometric data was successfully verified.

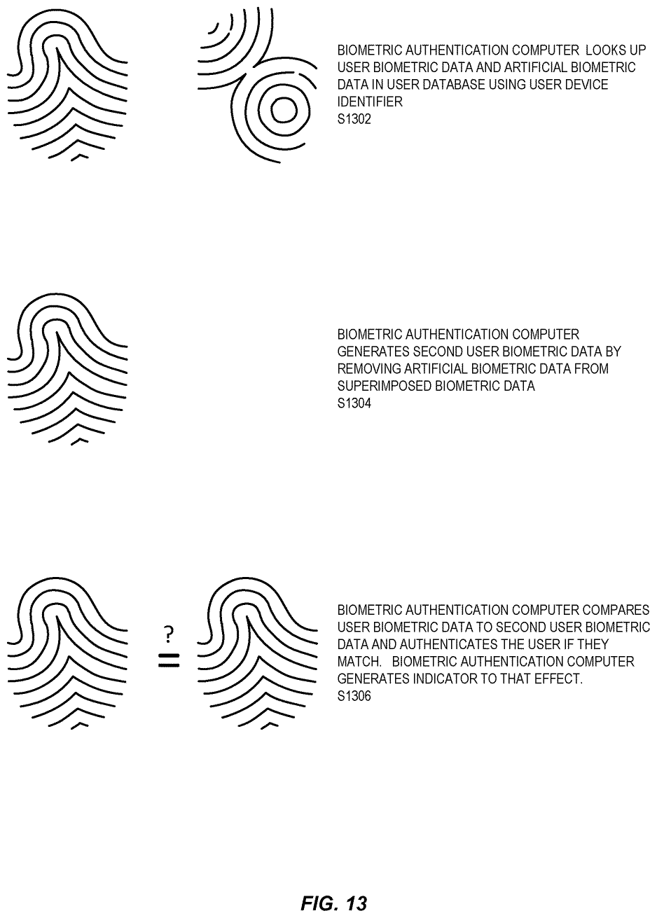

Other techniques for verifying superimposed biometric data can also be used. FIG. 13 shows a “subtractive” verification technique. As described above with reference to FIG. 7, at step S1302, the biometric authentication computer can identify user biometric data and artificial biometric data corresponding to the user device identifier. This can be accomplished by querying a user database using the user device identifier, or otherwise “looking up” the user biometric data and artificial biometric data in the user database.

At step S1304, the biometric authentication computer can generate second user biometric data by removing the artificial biometric data from the superimposed biometric data. This can be accomplished in a number of ways, including determining a difference between the superimposed biometric data and the artificial biometric data identified at step S1302. If, for example, the user biometric data, artificial biometric data and superimposed biometric data are represented as numerical arrays, and the superimposed biometric data comprises an elementwise sum of the user biometric data and artificial biometric data, the biometric authentication computer can perform elementwise subtraction of the artificial biometric data from the superimposed biometric data. The resulting difference can comprise the user biometric data. Similar techniques can be applied to different combination methods. For example, if the superimposed biometric data comprises an average of the numerical values corresponding to the user biometric data and the artificial biometric data, the numerical values of the artificial biometric data can first be halved before subtracting them from the numerical values of the superimposed biometric data, and the resulting difference can be doubled to produce the user biometric data.

From an information-theoretic perspective, many combination techniques that could be used to combine user biometric data and artificial biometric data may lead to information loss. As a result, this subtractive method may in some cases fail to perfectly reproduce the user biometric data. Consequently, the additive method described above may be preferable in some contexts or use cases.

At step S1306, the biometric authentication computer can compare the second user biometric data (generated at step S1304) to the user biometric data retrieved from the user database at step S1302 and authenticate the user if they match. As described above, the biometric authentication computer can generate an indicator to that effect, i.e., indicating whether the superimposed biometric data was successfully verified and the user successfully authenticated.

Many of the comments and observations made above about the additive method (described with reference to FIG. 12) are applicable to this subtractive method described with reference to FIG. 13. The second user biometric data may not exactly match the user biometric data corresponding to the user due to a variety of factors including the positioning of the biometric source (e.g., finger, retina, etc.) and the conditions under which the superimposed biometric data was captured (e.g., lighting in the room). Consequently, the biometric authentication computer can use approximate or threshold biometric data matching techniques, as summarized in broad detail below.

The biometric authentication computer can determine a similarity (or similarity score, similarity metric, etc.) between the second user biometric data and the user biometric data. Examples of similarity measures include the Jaccard (or Tanimoto) index, cosine similarity, Euclidean distance, a custom similarity measure, etc. Different similarity measures may be appropriate for different types of biometric data. The biometric authentication computer can verify the superimposed biometric data based on the similarity and a predetermined threshold, e.g., by verifying that the similarity is either greater than the predetermined threshold or less than the predetermined threshold, which may depend on the similarity metric being used. For example, for the Jaccard index, the biometric authentication computer can successfully authenticate the user if the similarity is greater than the predetermined threshold, and unsuccessfully authenticate the user if the similarity is less than the predetermined threshold. By contrast, for Euclidean distance, the biometric authentication computer can successfully authenticate the user if the similarity is less than the predetermined threshold, and unsuccessfully authenticate the user if the similarity is greater than the predetermined threshold.

In this way, the biometric authentication computer can verify the superimposed biometric data using the user biometric data and the artificial biometric data, thereby verifying that the superimposed biometric data corresponds to a user corresponding to a user device, which itself corresponds to the user device identifier. The biometric authentication computer can generate an indicator, which can indicate whether the superimposed biometric data was successfully verified.

### a) Subtract User Fingerprint Figure

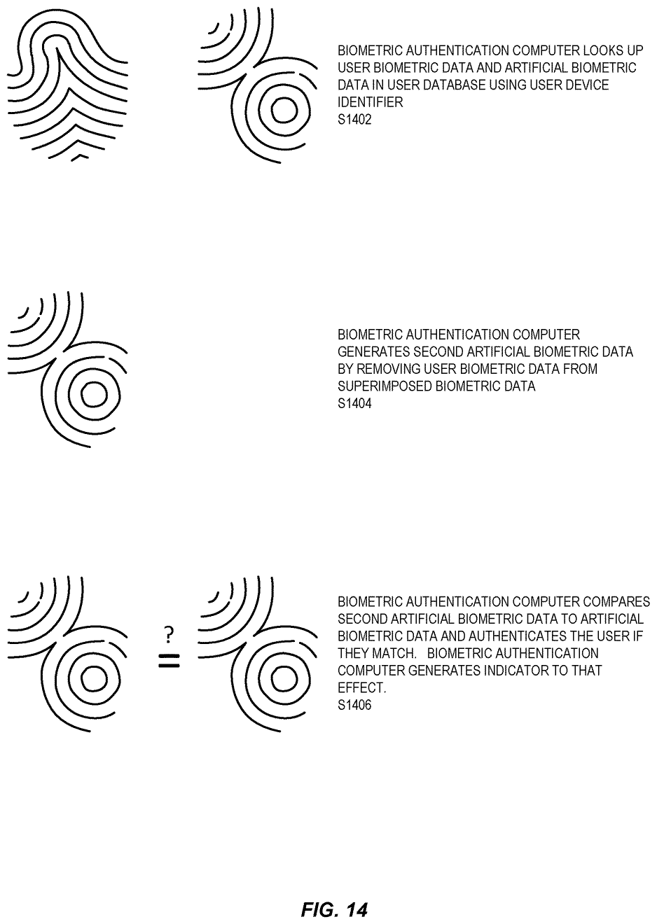

Other subtractive verification techniques can also be used. FIG. 14 shows a different subtractive verification technique. Unlike the method described with reference to FIG. 13, in which the biometric authentication computer can attempt to reproduce the user biometric data by “subtracting” artificial biometric data stored in a user database, in the method described below, the biometric authentication computer can attempt to reproduce the artificial biometric data by “subtracting” the user biometric data stored in the user database.

As described above in FIG. 7, at step S1402, the biometric authentication computer can identify user biometric data and artificial biometric data corresponding to the user device identifier. This can be accomplished by query a user database using the user device identifier, or otherwise “looking up” the user biometric data and artificial biometric data in the user database.

At step S1404, the biometric authentication computer can generate second artificial biometric data by removing the user biometric data from the superimposed biometric data. This can be accomplished in a number of ways, including determining a difference between the superimposed biometric data and the user biometric data identified at step S1402. If, for example, the user biometric data, artificial biometric data and superimposed biometric data are represented as numerical arrays, and the superimposed biometric data comprises an elementwise sum of the user biometric data and the artificial biometric data, the biometric authentication computer can perform elementwise subtraction of the user biometric data from the superimposed biometric data. The resulting difference can comprise the artificial biometric data. Similar techniques can be applied to different combination methods. For example, if the superimposed biometric data comprises an average of the numerical values corresponding to the user biometric data and the artificial biometric data, the numerical values of the user biometric data can first be halved before subtracting them from the numerical values of the superimposed biometric data, and the resulting difference can be doubled to produce the artificial biometric data.

From an information-theoretic perspective, many combination techniques that could be used to combine user biometric data and artificial biometric data may lead to information loss. As a result, this subtractive method may, in some cases, fail to perfectly reproduce the user biometric data. Consequently, the additive method described above with reference to FIG. 12 may be preferable in some contexts or use cases.

At step S1406, the biometric authentication computer can compare the second artificial biometric data (generated at step S1404) to the artificial biometric data retrieved from the user database at step S1402 and authenticate the user if they match. As described above, the biometric authentication computer can generate an indicator to that effect, i.e., indicating whether the superimposed biometric data was successfully verified and the user successfully authenticated.

Many of the comments and observations made above with reference to the methods of FIGS. 12 and 13 are applicable to this subtractive method described with reference to FIG. 14. The second artificial biometric data may not exactly match the artificial biometric data due to a variety of factors. Consequently, the biometric authentication computer can use approximate or threshold biometric data matching techniques, as summarized in broad detail below.

The biometric authentication computer can determine a similarity (or similarity score, similarity measure, similarity metric, etc.) between the second artificial biometric data and the artificial biometric data. Examples of similarity measures include the Jaccard (or Tanimoto) index, cosine similarity, Euclidean distance, a custom similarity measure, etc. Different similarity measures may be appropriate for different types of biometric data. The biometric authentication computer can verify the superimposed biometric data based on the similarity and a predetermined threshold, e.g., by verifying that the similarity is either greater than the predetermined threshold or less than the predetermined threshold, which may depend on the similarity metric being used. For example, for the Jaccard index, the biometric authentication computer can successfully authenticate the user if the similarity is greater than the predetermined threshold, and unsuccessfully authenticate the user if the similarity is less than the predetermined threshold. By contrast, for Euclidean distance, the biometric authentication computer can successfully authenticate the user if the similarity is less than the predetermined threshold, and unsuccessfully authenticate the user if the similarity is greater than the predetermined threshold.

In this way, the biometric authentication computer can verify the superimposed biometric data using the user biometric data and the artificial biometric data, thereby verifying that the superimposed biometric data corresponds to a user corresponding to a user device, which itself corresponds to the user device identifier. The biometric authentication computer can further generate an indicator, which can indicate whether the superimposed biometric data was successfully verified.

Returning to FIG. 7, at step S734, the biometric authentication computer 712 can transmit the indicator. Depending on the particular context or use case for biometric authentication, the recipient of the indicator may change. For example, for a building access control system, if biometric authentication (and therefore the indicator) is the sole factor for determining whether the user 702 should be allowed to access a secure building, then the biometric authentication computer 712 can transmit the indicator to the resource provider computer 708 or access device 706 (via, e.g., the processing computer and transport computer 710). Either the resource provider computer 708, the access device 706 or one of their respective operators can then enact steps to grant the user 702 access to the building.

However, it is also possible that biometric authentication may only be one factor used to authorize some interaction between the user 702 and the resource provider. A credit card transaction, for example, may ultimately depend on authorization by an issuing bank, which issued the user device 704 (e.g., a credit card) to the user 702. This issuing bank may operate an authorization computer 714, which may be used to automatically approve or deny attempted credit card transactions performed by its cardholders. As such, in some embodiments at step S734, the biometric authentication computer 712 can include the indicator in the authorization request message and transmit the authorization request message to the authorization computer 714 (e.g., via the processing computer). Alternatively, the biometric authentication computer 712 can transmit the indicator to the processing computer, which can then include the indicator in the authorization request message sent to the authorization computer 714.

Steps S736-S744 may be optional, depending on whether an authorization computer 714 is needed to authorize some interaction (e.g., a transaction) between the user 702 and a resource provider. At step S736, the authorization computer 714 can authorize or deny the authorization request message based in part on the indicator. In doing so, the authorization computer 714 can generate an authorization response message, which indicates whether some interaction has been approved or denied. The authorization computer 714 may have its own logic or procedures for authorizing interactions. For example, the authorization computer 714 may compute a risk score based on a variety of data included in the authorization request message, then authorize or deny the interaction based on the risk score. In the context of credit card transactions, a frequently performed low cost transaction with a known merchant, for which the user 702 has been successfully biometrically authenticated may have a low risk score, and may have a high probability of being approved by the authorization computer 714. By contrast, an unusual high cost transaction with an unknown merchant may be denied, even if the user 702 has been successfully biometrically authenticated.

Steps S738-S744 can comprise steps associated with the transmission of the authorization response message. At step S738, the authorization computer 714 can transmit the authorization response message to the processing computer. Subsequently, at step S740, the processing computer can transmit the authorization response message to the transport computer 710. At step S742, the transport computer 710 can transmit the authorization response message to the resource provider computer 708, and at step S744, the resource provider computer can transmit the authorization response message to the access device 706. These transmissions may occur via any suitable communication network (e.g., the Internet) and may conform to any suitable communication protocol (e.g., ISO 8583, a protocol for communicating payment information).

Some or all of these steps may be optional. In some embodiments, the authorization computer 714 may transmit the authorization response message back to the access device 706 directly. Alternatively, for a biometric authentication network that does not comprise a transport computer 710 (for example), the processing computer can transmit the authorization response message to resource provider computer 708.

Any of the computers or devices in the “chain of transmission” between the authorization computer 714 and the access device 706 can interpret the authorization response message as necessary. For example, the transport computer 710 may comprise a computer system associated with an acquiring bank, which maintains a bank account on behalf of the resource provider (merchant). An authorization request message that indicates that a transaction has been authorized may result in a transfer of funds between a user 702 bank account maintained by an issuing bank (which may operate the authorization computer 714) and a resource provider bank account maintained by the acquiring bank. The transport computer 710 may analyze or interpret the authorization response message to determine if a clearing and settlement process is needed between the two banks.

Likewise, the resource provider computer 708 may be operated by a resource provider (e.g., a merchant or an employee of a merchant) who may wish to determine whether or not they should provide some resource (e.g., goods) to the user 702, and who therefore may wish to know whether the interaction (e.g., transaction) has been approved or denied. The resource provider computer 708 may interpret the authorization response message and display some message (e.g., on a monitor) indicating whether the interaction has been approved or denied. Likewise, the access device 706 may display a similar message in order to inform the user 702 of the status of the interaction.

At this point some action or interaction can take place, which is dependent largely on the context or use case for the biometric authentication system. If the biometric authentication system is being used to provide an additional layer of security for credit card transactions, a resource provider merchant can either provide the user 702 with purchased goods or services (for authorization response messages indicating that the transaction has been approved) or not (for authorization response messages indicating that the transaction has not been approved). For a building access control system, the resource provider can either allow the user 702 access to the building or not allow the user 702 access to the building, depending on the authorization response message.

In some cases, it may be useful to periodically update the artificial biometric data used to generate the superimposed fingerprint. Much like how IT (information technology) departments prompt users to update their passwords every few months and credit card numbers are subject to expiration, periodically updating artificial biometric data can provide a security benefit. If an identity thief manages to steal superimposed biometric data (derived in part from artificial biometric data), they can conceivably use that superimposed biometric data to impersonate a user. However, once the artificial biometric data is updated and replaced with new artificial biometric data, the stolen superimposed biometric data is no longer valid. Consequently, periodically updating artificial biometric data limits the ability of identity thieves to use stolen superimposed biometric data to impersonate users.

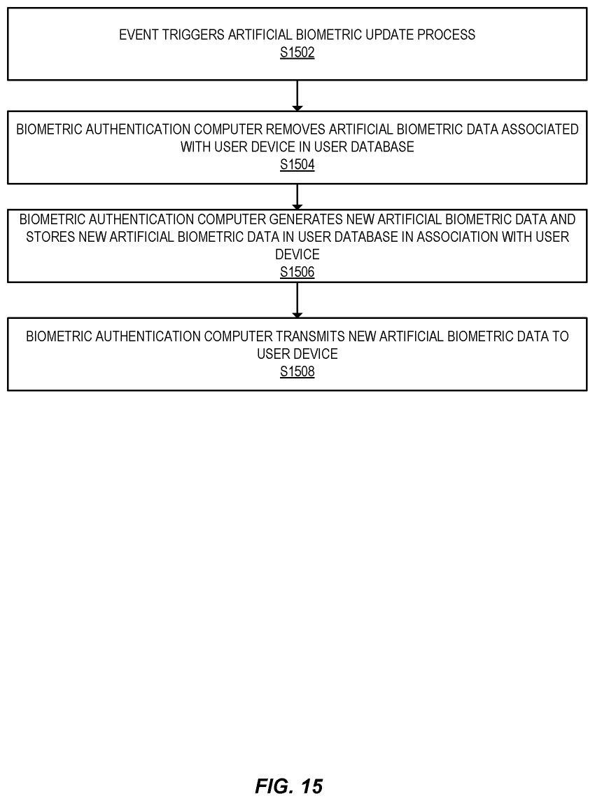

FIG. 15 shows a flowchart of an artificial biometric data updating process according to some embodiments. At step S1502, some event can trigger the artificial biometric update process. For example, a user attempting to authenticate themselves using a biometric authentication system can trigger the biometric update process. An artificial biometric may only be valid for a certain number of usages, such as 100. When the artificial biometric is used on the 100^{th} usage, the artificial biometric update process may be triggered. Alternatively, an artificial biometric may only be valid in a certain date range. When the artificial biometric is used after the date range, the artificial biometric update process may be triggered. The biometric authentication computer can determine that the artificial biometric data has expired or is near expiration, e.g., based on either a recorded number of usages, valid date ranges, or any other appropriate means of checking an expiration status.

At step S1504, the biometric authentication computer can identify a user record in the user database corresponding to the artificial biometric data that is expiring or near expiration. The biometric authentication computer can then remove the artificial biometric data from the user record in the user database. The biometric authentication computer can use any appropriate database access and management means to identify the user record and remove the artificial biometric data, e.g., querying the user database using information such as a user device identifier and using SQL-style DELETE statements to remove the relevant artificial biometric data from the user record.

At step S1506, the biometric authentication computer can generate new artificial biometric data and store the new artificial biometric data in the user record. The biometric authentication computer can use any appropriate means to generate the new artificial biometric data. For example, the biometric authentication computer can use a machine learning model trained using biometric data (e.g., data corresponding to a variety of captured fingerprints) to generate artificial biometric data. However as described above, while the artificial biometric data may have similar data characteristics to user biometric data, it may also comprise any data that sufficiently obscures the user biometric data when combined. Consequently, any procedure or process that can be used to generate data that sufficiently obfuscates the user biometric data can be employed, such as a random number generator.

At step S1508, the biometric authentication computer can transmit the new artificial biometric data to the user device. This can be accomplished, for example, using the network depicted in FIGS. 2 and 7, i.e., the biometric authentication computer can transmit the new artificial biometric data to the user device via a processing computer, transport computer, resource provider computer, access device, etc. This update process can be integrated into a biometric authentication process. That is, when the user is attempting to authenticate using superimposed biometric data (generated using artificial biometric data near expiration), the biometric authentication computer can both authenticate the user and then update the artificial biometric data. A response message (e.g., an authorization response message) transmitted back to an access device and the user device can both contain the authentication status or indicator (i.e., indicating whether the user was successfully biometrically authenticated), as well as the new artificial biometric data.

The user device can receive the new artificial biometric data by interfacing with the access device. The user device can then remove the old artificial biometric data from its memory and replace it with the new artificial biometric data, thereby completing the artificial biometric data update process. In subsequent authentications, the user device can use the new artificial biometric data to generate superimposed biometric data used for authentication.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, all of the steps of any of the methods can be performed with modules, circuits, or other means for performing these steps.

The specific details of particular embodiments may be combined in any suitable manner without departing from the spirit and scope of embodiments of the invention. However, other embodiments of the invention may involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
interfacing, by a user device, with an access device;
determining, by the user device, superimposed biometric data comprising a combination of user biometric data and artificial biometric data; and
transmitting, by the user device, to a biometric authentication computer, the superimposed biometric data and a user device identifier corresponding to the user device, wherein the biometric authentication computer verifies that the superimposed biometric data corresponds to a user corresponding to the user device by using the superimposed biometric data and the user device identifier.

2. The method of claim 1, further comprising, prior to determining, by the user device, the superimposed biometric data:
capturing, by the user device, via a biometric capture layer, a biometric sample of a user, wherein the biometric data is derived from the biometric sample.

3. The method of claim 1, wherein the step of interfacing, by the user device, with the access device occurs after the step of determining, by the user device, the superimposed biometric data, and wherein the user device interfaces with the access device via near field communication or by establishing physical contact between a user device interface and an access device interface.

4. The method of claim 1, wherein the user device transmits the superimposed biometric data to the biometric authentication computer via the access device.

5. The method of claim 1, wherein the method further comprises:
receiving, by the user device, a transmission of electrical power from the access device, thereby powering a biometric capture layer used to determine the superimposed biometric data and one or more electrical elements located in the user device.

6. The method of claim 1, wherein prior to determining, by the user device, superimposed biometric data comprising the combination of user biometric data and artificial biometric data, the method comprises:
receiving, by the user device, from the biometric authentication computer, the artificial biometric data, wherein the artificial biometric data was generated by the biometric authentication computer during an enrollment process; and
storing, by the user device, the artificial biometric data in a memory element.

7. The method of claim 1, wherein determining, by the user device, the superimposed biometric data comprises:
capturing, by the user device, via a biometric capture layer, a biometric sample of the user;
generating, by the user device, the user biometric data based on the biometric sample;
retrieving, by the user device, the artificial biometric data; and
digitally combining, by the user device, the user biometric data and the artificial biometric data, thereby determining the superimposed biometric data.

8. The method of claim 1, wherein determining, by the user device, the superimposed biometric data comprises:
rendering, by the user device, an artificial biometric sample on a biometric obfuscation layer, the biometric obfuscation layer located between a biometric capture layer and a biometric source; and
capturing, by the user device, using the biometric capture layer, a superimposed biometric sample comprising the combination of the artificial biometric sample rendered on the biometric obfuscation layer and a biometric sample of the 8 user, thereby determining the superimposed biometric data.

9. The method of claim 8, wherein the biometric sample comprises a fingerprint, and wherein the biometric source comprises a finger corresponding to the user.

10. The method of claim 8, wherein the biometric obfuscation layer comprises a transparent display, wherein the biometric capture layer comprises an optical sensor, and wherein the user device renders the artificial biometric sample on the biometric obfuscation layer by displaying the artificial biometric sample on the transparent display.

11. The method of claim 8, wherein the biometric obfuscation layer comprises an electrode array comprising a plurality of electrodes, wherein the biometric capture layer comprises a mutual capacitance sensor array, and wherein the user device renders the artificial biometric sample on the biometric obfuscation layer by manipulating a plurality of voltages corresponding to the plurality of electrodes.

12. The method of claim 8, wherein the biometric obfuscation layer comprises an ultrasonic transmitter array comprising a plurality of ultrasonic transmitters, wherein the biometric capture layer comprises an ultrasonic sensor, and wherein the user device renders the artificial biometric sample on the biometric obfuscation layer by driving the plurality of ultrasonic transmitters, thereby generating a plurality of ultrasonic waves corresponding to the artificial biometric sample.

13. A method comprising:
receiving, by a biometric authentication computer, a request message comprising a user device identifier and superimposed biometric data;
identifying, by the biometric authentication computer, user biometric data and artificial biometric data corresponding to the user device identifier;
verifying, by the biometric authentication computer, the superimposed biometric data using the user biometric data and the artificial biometric data, thereby verifying that the superimposed biometric data corresponds to a user corresponding to a user device corresponding to the user device identifier;
generating, by the biometric authentication computer, an indicator, the indicator indicating whether the superimposed biometric data was successfully verified; and
transmitting, by the biometric authentication computer, the indicator.

14. The method of claim 13, wherein the biometric authentication computer receives the request message from an access device interfacing with the user device.

15. The method of claim 13, wherein the request message comprises an authorization request message and wherein the step of transmitting, by the biometric authentication computer, the indicator comprises:
including, by the biometric authentication computer, the indicator in the authorization request message; and
transmitting, by the biometric authentication computer, to an authorization computer, the authorization request message, wherein the authorization computer authorizes or denies the authorization request message based in part on the indicator.

16. The method of claim 13, wherein verifying, by the biometric authentication computer, the superimposed biometric data using the user biometric data and the artificial biometric data comprises:
generating second superimposed biometric data by combining the user biometric data and the artificial biometric data;
determining a similarity between the second superimposed biometric data and the superimposed biometric data; and
verifying the superimposed biometric data based on the similarity and a predetermined threshold.

17. The method of claim 13, wherein verifying, by the biometric authentication computer, the superimposed biometric data using the user biometric data and the artificial biometric data comprises:
generating second user biometric data by determining a difference between the superimposed biometric data and the artificial biometric data;
determining a similarity between the second user biometric data and the user biometric data; and
verifying the superimposed biometric data based on the similarity and a predetermined threshold.

18. The method of claim 13, wherein the user biometric data comprises fingerprint data.

19. The method of claim 13, further comprising:
determining, by the biometric authentication computer, that the artificial biometric data has expired or is near expiration;
removing, by the biometric authentication computer, the artificial biometric data from a user record in a user database;
generating, by the biometric authentication computer, new artificial biometric data;
storing, by the biometric authentication computer, the new artificial biometric data in the user record; and
transmitting, by the biometric authentication computer, the new artificial biometric data to the user device.

20. A user device comprising:
a processor; and
a non-transitory computer readable media coupled to the processor, the non-transitory computer readable media comprising code, executable by the processor, for performing a method comprising:
interfacing with an access device;
determining superimposed biometric data comprising a combination of user biometric data and artificial biometric data; and
transmitting to a biometric authentication computer, the superimposed biometric data and a user device identifier corresponding to the user device, wherein the biometric authentication computer verifies that the superimposed biometric data corresponds to a user corresponding to the user device by using the superimposed biometric data and the user device identifier.
